(19) United States
(12) Patent Application Publication
(10) Pub. No.: US 2023/0319657 A1
(43) Pub. Date: Oct. 5, 2023

(54) MOBILITY MANAGEMENT TECHNIQUES IN A WIRELESS COMMUNICATION SYSTEM

(71) Applicant: QUALCOMM Incorporated, San Diego, CA (US)

(72) Inventors: Arvind Vardarajan Santhanam, San Diego, CA (US); Tom Chin, San Diego, CA (US); Wei-Jei Song, San Diego, CA (US); Rajeev Pal, San Diego, CA (US); Kuo-Chun Lee, San Diego, CA (US); Mouaffac Ambriss, San Diego, CA (US)

(21) Appl. No.: 17/709,313

(22) Filed: Mar. 30, 2022

(51) Int. Cl. H04W 36/00; H04W 24/08

(52) U.S. Cl. CPC H04W 36/0085; H04W 24/08

(57) ABSTRACT

This disclosure provides systems, methods, and apparatuses to manage mobility in a wireless communication system. A user equipment (UE) may include a wireless communication apparatus and an application processor (AP). In some aspects, the wireless communication apparatus may monitor cells using a first criterion to detect problematic cells. For example, the first criterion may be associated with a history of ping-pong events or a history of data transmission errors. The wireless communication apparatus may select a cell for communication using a cell selection criteria that deprioritizes selection of problematic cells. In some aspects, the wireless communication apparatus may receive a list of cells from the AP or a server, the list identifying cells considered to be problematic cells. The wireless communication apparatus may adjust the first criterion to expedite detection of problematic cells. In some aspects, the server may aggregate and redistribute information about problematic cells from a plurality of UEs.

### TECHNICAL FIELD

Aspects of the present disclosure generally relate to wireless communication and mobility management techniques associated with cell selection in a wireless communication system.

### DESCRIPTION OF THE RELATED TECHNOLOGY

Wireless communication systems are widely deployed to provide various types of communication content such as voice, video, packet data, messaging, broadcast, and so on. These systems may be capable of supporting communication with multiple users by sharing the available system resources (for example, time, frequency, and power). A wireless communication system may include one or more base stations or one or more network access nodes, each simultaneously supporting communication for multiple communication devices, which may be otherwise known as user equipment (UE). Different base stations or network access nodes may implement different radio communication protocols including fourth-generation (4G) systems such as Long Term Evolution (LTE) systems, LTE-Advanced (LTE-A) systems, or LTE-A Pro systems, and fifth-generation (5G) systems which may be referred to as New Radio (NR) systems. NR, which also may be referred to as 5G for brevity, is a set of enhancements to the LTE mobile standard promulgated by the Third Generation Partnership Project (3GPP).

A UE may perform a cell selection (or reselection) to select a serving cell of a base station for a wireless connection to the wireless communication network. Cell selection may occur during an idle state (such as when the UE is selecting a serving cell) or during a connected state (such as when the UE is already connected to a current serving cell). Cell selection is a technique to support mobility of the UE as it encounters different cells due to movement. Traditionally, the cell selection may be associated with signal measurements of a various cells. For example, in the idle state, the UE may select a cell so that it intends to use when a connection is established. In the connected state, the UE may transmit a signal measurement report to the wireless communication network when a neighbor cell satisfies a cell selection criterion for triggering a handover to the neighbor cell. Such techniques may be referred to as handover procedures, and help to provide continuous connectivity to a UE as the UE changes locations or determines a neighbor cell has a better signal. There is a desire to improve cell selection techniques to accommodate mobility of and improve service for applications of the UE.

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method. The method may include monitoring, by a wireless communication apparatus of a user equipment (UE), one or more cells including at least a first cell of a wireless communication network in association with at least a first criterion. The first criterion may be associated with a history of handover events or a history of data transmission errors indicative of problematic cells. The method may include selecting a primary cell of the wireless communication network using a cell selection criteria that deprioritizes selection of a first cell when the first cell is a problematic cell according to the first criterion. The method may include communicating with the wireless communication network using the primary cell.

In some implementations, the method may include receiving, by the wireless communication apparatus of the UE, a list of cells considered to be problematic cells by an application processor (AP) or device processor of the UE. The method may include monitoring at least one candidate cell that is in the list of cells from the AP or device processor using a second criterion for the candidate cell. The second criterion may have a lower threshold compared to the first criterion such that the monitoring expedites an indication of the candidate cell as a problematic cell.

In some implementations, the method may include communicating an identification of the first cell as the problematic cell to a server that aggregates problematic cell information from more than one UE in the wireless communication network.

In some implementations, the method may include receiving, from a server, aggregated problematic cell information that is associated with problematic cells identified by more than one UE in the wireless communication network.

Another innovative aspect of the subject matter described in this disclosure can be implemented in a UE. The UE may include a wireless communication apparatus configured to monitor one or more cells including at least a first cell of a wireless communication network in association with at least a first criterion. The first criterion may be associated with a history of handover events or a history of data transmission errors indicative of problematic cells. The wireless communication apparatus may select a primary cell of the wireless communication network using a cell selection criteria that deprioritizes selection of a first cell when the first cell is a problematic cell according to the first criterion. The UE may include at least one modem configured to communicate with the wireless communication network using the primary cell.

Another innovative aspect of the subject matter described in this disclosure can be implemented in a server for managing mobility in a wireless communication network. The server may include a communication unit configured to obtain cell information from more than one UE in the wireless communication network, the cell information identifying one or more problematic cells. The server may include a processing system configured to generate aggregated problematic cell information associated with the one or more problematic cells identified by the cell information. The communication unit may be further configured to output the aggregated problematic cell information to a recipient.

Another innovative aspect of the subject matter described in this disclosure can be implemented in a method for managing mobility in a wireless communication network. The method may include receiving cell information from more than one UE in the wireless communication network, the cell information identifying one or more problematic cells. The method may include generating aggregated problematic cell information associated with the one or more problematic cells identified by the cell information. The method may include communicating the aggregated problematic cell information to a recipient.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows a pictorial diagram conceptually illustrating an example of a wireless communication system.

FIG. 2 shows a block diagram conceptually illustrating an example of a base station (BS) in communication with a user equipment (UE).

FIG. 3 shows a block diagram conceptually illustrating an example wireless communication system in which a UE may perform cell selection.

FIG. 4 shows a pictorial diagram conceptually illustrating example mobility management techniques of a UE in a wireless communication system.

FIG. 5 shows a flowchart illustrating an example process for wireless communication by a UE.

FIG. 6 shows a timing diagram illustrating cell selection and an example technique for detecting a problematic cell.

FIG. 7 shows a timing diagram illustrating cell selection and additional example techniques for detecting a problematic cell.

FIG. 8 shows a timing diagram illustrating example techniques in which an application processor (AP) of the UE provides identifications of one or more cells considered to be problematic cells by the AP.

FIG. 9 shows a flowchart illustrating an example process for a wireless communication apparatus of a UE to validate cell information received by an application processor of the UE.

FIG. 10 shows a flowchart illustrating an example process for monitoring a cell using criteria indicative of problematic cells.

FIG. 11 shows a flowchart illustrating an example process of a server for aggregating problematic cell information.

FIG. 12 shows a timing diagram illustrating example techniques in which one or more UEs provide problematic cell information to a server configured to aggregate and redistribute problematic cell information.

FIG. 13 shows a conceptual diagram illustrating example techniques in which location data may be used to identify problematic areas of problematic cells.

FIG. 14 shows a conceptual diagram of an example message according to some implementations.

FIG. 15 shows a block diagram of an example wireless communication apparatus.

FIG. 16 shows a block diagram of an example mobile communication device.

FIG. 17 shows a block diagram of another example wireless communication apparatus that supports cell selection techniques according to some implementations.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. Some of the examples in this disclosure are based on wireless communication according to the 3rd Generation Partnership Project (3GPP) wireless standards, such as the Long Term Evolution (LTE) and 5G standards. However, the described implementations may be implemented in any device, system or network that is capable of transmitting and receiving radio frequency signals according to any of the wireless communication standards, including any of the Institute of Electrical and Electronics Engineers (IEEE) 802.11 wireless standards, the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), AMPS, or other known signals that are used to communicate within a wireless, cellular or internet of things (IOT) network, such as a system utilizing 3G, 4G or 5G, or further implementations thereof, technology.

A wireless communication system (which also may be referred to as a wireless communication network) may include one or more radio access networks (RANs) that provide access for a user equipment (UE) to communicate with other nodes in the wireless communication system. A radio access network (RAN, sometimes also referred to as a radio network, or access network) may include a number of network nodes (such as base stations (BSs)) that can support communication for a number of user equipment (UEs). A user equipment (UE) may include a wireless communication apparatus (sometimes referred to as a communication module, communication unit, wireless communication interface, communication chipset, or the like) and an application processor (AP). The AP also may be referred to as a device processor. The AP may execute user applications and the operating system of the UE, while the wireless communication apparatus may be a component of the UE that communicates with a BS of the wireless communication network. For example, the wireless communication apparatus may implement a radio resource control (RRC) protocol for establishing, maintaining, or modifying a radio connection to a BS via a cell. In 3GPP, the term “cell” can refer to a coverage area of a BS, a BS subsystem serving this coverage area, or a combination thereof, depending on the context in which the term is used. The wireless communication apparatus also may select a serving cell from among cells available from various BSs in an area.

Cell selection may refer to selection or reselection of a cell. For example, cell selection may refer to “selection” or “reselection” of a serving cell when the wireless communication apparatus is in an idle state before connecting to the wireless communication network. Cell selection also may refer to cell reselection when the wireless communication apparatus is in a connected state and selects a new serving cell to use instead of the current serving cell. For example, the wireless communication apparatus may perform a handover from a current serving cell to a new serving cell. Occasionally, the wireless communication apparatus may experience a series of cell selections which include selection of a first cell, followed by selection of a second cell, and then subsequent selection of the first cell again. A “ping-pong” may refer to a pattern of cell selections in selection alternates between a first cell and a second cell. In the context of a connected state, the ping-pong may include a handover from the first cell to a second cell and then a subsequent handover back to the first cell. In the context of an idle state, the ping-pong may include a first selection of the first cell, a second reselect of the second cell, and then a third selection of the first cell again. A ping-pong situation occurs when there are frequent handovers or reselections occurring between two or more cells.

A problematic cell may refer to a cell that is associated with a history of ping-pong events that includes frequent handovers or reselection between a pair of cells during a preceding time period. A problematic cell also may refer to a cell that is associated with a history of data transmission errors, such as frequent occurrences of congestion or signal loss during a preceding time period. There may be a desire to deprioritize problematic cells when performing a cell selection (during either an idle state or a connected state). Having a cell selection technique that reduces prioritization of problematic states may mitigate against ping-pong situations or camping on a cell having data transmission errors.

This disclosure provides systems, methods, and apparatuses to manage mobility in a wireless communication system. Mobility management may refer to cell selection techniques of the wireless communication apparatus. In some aspects, the wireless communication apparatus may monitor cells using a first criterion to detect problematic cells. For example, the first criterion may be associated with a history of ping-pong events or a history of data transmission errors. The wireless communication apparatus may select a cell for communication using a cell selection criteria that deprioritizes selection of problematic cells. Deprioritizing selection of problematic cells also may be referred to as “mitigation” since deprioritizing cell selection of problematic cells mitigates against excessive reselections, handovers or data transmission errors. In some implementations, the wireless communication apparatus may maintain a list of problematic cells that have been detected as problematic cells using the first criterion.

In some aspects, the wireless communication apparatus may receive, from the AP of the UE a list of cells considered to be problematic cells by the AP or device processor. For example, an original equipment manufacturer (OEM) may maintain a list of cells considered to be problematic cells by the OEM. The OEM may store the list of cells in a memory of the UE. The AP or the device processor may be configured to provide the list of cells to the wireless communication apparatus. Thus, the wireless communication apparatus may have more than one source of information identifying problematic cells—that which it has generated and that which has been received from the AP. This disclosure provides techniques for a wireless communication apparatus to make use of multiple sources of problematic cell information when performing cell selection.

In some aspects, the wireless communication apparatus may deprioritize selection of cells identified by the AP. In some implementations, the wireless communication apparatus may validate whether the cells identified by AP are problematic cells that should be deprioritized. For example, the wireless communication apparatus may compare the list of cells received from the AP with a list of problematic cells generated by the wireless communication apparatus. In some implementations, the wireless communication apparatus may adjust the criterion used to confirm a cell as a problematic cells. For example, the wireless communication apparatus may adjust (such as reduce) a threshold by which a cell is confirmed to be a problematic cell. In some implementations, the wireless communication apparatus may be configured to provide a status to the AP regarding which cells are confirmed to be problematic cells, which cells are being monitored as potentially problematic cells, and which cells are not problematic cells.

Additionally, or alternatively, a server may store aggregated problematic cell information obtained from multiple UEs, OEMs, application providers, or any combination thereof. As an example, the server may be located in a packet data network accessible via the wireless communication system. The server may aggregate problematic cell information from multiple sources and redistribute aggregated problematic cell information to a UE. The UE may use the aggregated problematic cell information to deprioritize selection of cells identified by the aggregated problematic cell information.

In some aspects, the cell information from the AP, device processor, or server may be identified by location data. For example, the cell information may include location data that collectively describes a cluster of problematic cells. In one example, the location data may identify a geolocation area by a central coordinate and a distance radius. In another example, the location data may identify area boundaries for a polygonal area that encompasses the cluster of problematic cells. In yet another example, the location data may include one or more wireless local area network (WLAN) basic service set identifiers (BSSIDs) which are associated with coverage areas that overlap the problematic cells. The wireless communication apparatus may utilize the location data to determine that the UE is in an area associated with a cluster of problematic cells.

Particular implementations of the subject matter described in this disclosure can be implemented to realize one or more of the following potential advantages. Excessive reselections and handovers may cause interruptions to connectivity and diminish the user experience. The interruptions may introduce latency during a ping-pong event, may reduce throughput or otherwise may decrease user satisfaction with the network performance. The techniques in this disclosure may mitigate against excessive ping-pong situations. Additionally, or alternatively, the techniques of this disclosure may enable a wireless communication apparatus to connect to a serving cell that experiences fewer data transmission errors.

The mobility management techniques disclosed herein involve cell selection performed by a UE in a connected state, an idle state, or an inactive state. While some examples are described with reference to handovers (in connected state) or cell reselection (in idle state or inactive state), the cell selection techniques may be interchangeably used in the connected state, the idle state, or the inactive state.

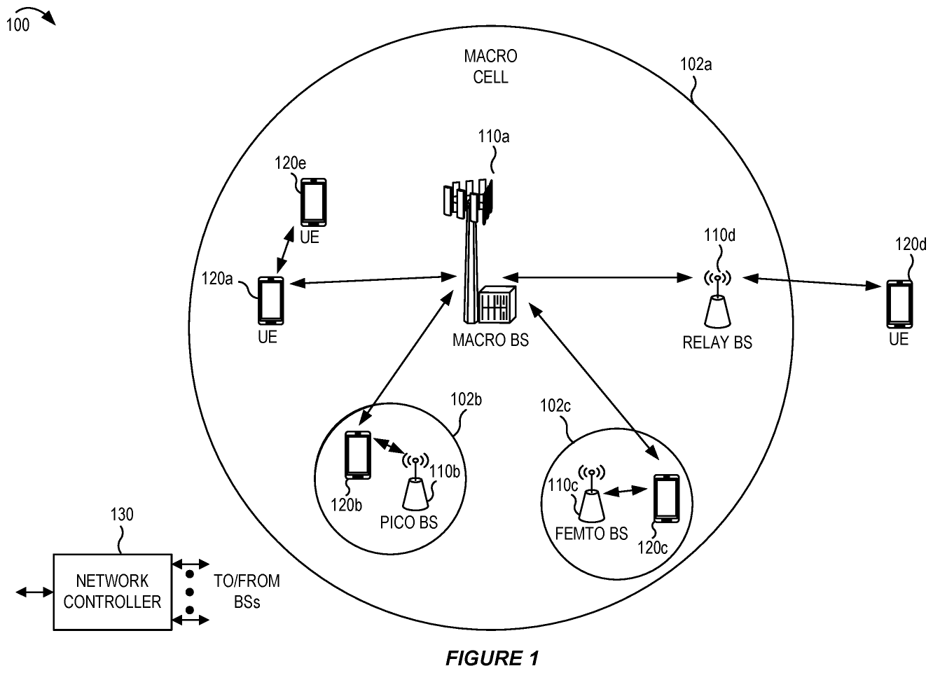

FIG. 1 is a block diagram conceptually illustrating an example of a wireless communication system 100. The wireless communication system 100 may include an LTE RAN or some other RAN, such as a 5G or NR RAN. The wireless communication system 100 may include a number of BSs 110 (shown as BS 110a, BS 110b, BS 110c, and BS 110d) and other network entities. A BS is an entity that communicates with user equipment (UEs) and also may be referred to as a base station, a Node B, an LTE evolved Node B (eNB), a next generation Node B (gNB), a NR BS, a 5G node B (NB), an access point, a transmit receive point (TRP), among other examples, depending on the wireless communication standard that the BS supports. Each BS may provide communication coverage for a particular geographic area. In 3GPP, the term “cell” can refer to a coverage area of a BS, a BS subsystem serving this coverage area, or a combination thereof, depending on the context in which the term is used. A UE may communicate with a base station via the downlink (DL) and uplink (UL). The DL (or forward link) refers to the communication link from the BS to the UE, and the UL (or reverse link) refers to the communication link from the UE to the BS. Although not shown for simplicity, BSs (such as BS 110) may refer to both monolithic BSs, as well as disaggregated BSs, such as those with disaggregated RAN (D-RAN) or open RAN (O-RAN) architectures, which may include one or more disaggregated constituent components, such as a central unit (CU), distributed unit (DU), and a radio unit (RU).

A BS may provide communication coverage for a macro cell, a pico cell, a femto cell, another type of cell, or a combination thereof. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example, three) cells. The terms “eNB,” “base station,” “NR BS,” “gNB,” “TRP,” “AP,” “node B,” “5G NB,” and “cell” may be used interchangeably herein.

In some examples, a cell may not necessarily be stationary, and the geographic area of the cell may move according to the location of a mobile BS. In some examples, the BSs may be interconnected to one another as well as to one or more other BSs or network nodes (not shown) in the wireless communication system 100 through various types of backhaul interfaces, such as a direct physical connection, a virtual network, or a combination thereof using any suitable transport network.

The wireless communication system 100 also may include relay stations. A relay station is an entity that can receive a transmission of data from an upstream station (for example, a BS or a UE) and send a transmission of the data to a downstream station (for example, a UE or a BS). A relay station also may be a UE that can relay transmissions for other UEs. In the example shown in FIG. 1, a relay station 110d may communicate with macro BS 110a and a UE 120d in order to facilitate communication between BS 110a and UE 120d. A relay station also may be referred to as a relay BS, a relay base station, or a relay, among other examples.

The wireless communication system 100 may include a heterogeneous network that includes BSs of different types, for example, macro BSs, pico BSs, femto BSs, relay BSs, among other examples. These different types of BSs may have different transmit power levels, different coverage areas, and different impacts on interference in wireless communication system 100. For example, macro BSs may have a high transmit power level (for example, 5 to 40 Watts) whereas pico BSs, femto BSs, and relay BSs may have lower transmit power levels (for example, 0.1 to 2 Watts).

A network controller 130 may couple to a set of BSs and may provide coordination and control for these BSs. The network controller 130 may communicate with the BSs via a backhaul. The BSs also may communicate with one another, for example, directly or indirectly via a wireless or wireline backhaul.

UEs 120 (for example, 120a, 120b, 120c) may be dispersed throughout wireless communication system 100, and each UE may be stationary or mobile. A UE also may be referred to as an access terminal, a terminal, a mobile station, a subscriber unit, or a station, among other examples. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, among other examples, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices or may be implemented as NB-IoT (narrowband internet of things) devices. Some UEs may be considered a Customer Premises Equipment (CPE). UE 120 may be included inside a housing that houses components of UE 120, such as processor components, memory components, similar components, or a combination thereof.

In general, any number of RANs may be deployed in a given geographic area. Each RAN may support a particular RAT and may operate on one or more frequencies. A RAT also may be referred to as a radio technology, an air interface, among other examples. A frequency also may be referred to as a carrier, a frequency channel, among other examples. Each frequency may support a single RAT in a given geographic area in order to avoid interference between RANs of different RATs. In some cases, NR or 5G RANs may be deployed. 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with a ultra-high density (such as ˜1M nodes/km2), ultra-low complexity (such as ˜10 s of bits/sec), ultra-low energy (such as ˜10+ years of battery life), and deep coverage with the capability to reach challenging locations; (2) including mission-critical control with strong security to safeguard sensitive personal, financial, or classified information, ultra-high reliability (such as 99.9999% reliability), ultra-low latency (such as ˜1 millisecond (ms)), and users with wide ranges of mobility or lack thereof; and (3) with enhanced mobile broadband including extreme high capacity (such as ˜10 Tbps/km2), extreme data rates (such as multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with UL/downlink scheduling information, data, and acknowledgement in the same subframe. The self-contained integrated subframe supports communications in unlicensed or contention-based shared spectrum, adaptive UL/downlink that may be flexibly configured on a per-cell basis to dynamically switch between UL and downlink to meet the current traffic needs.

In some examples, access to the air interface may be scheduled, where a scheduling entity (for example, a base station) allocates resources for communication among some or all devices and equipment within the scheduling entity's service area or cell. Within the present disclosure, as discussed further below, the scheduling entity may be responsible for scheduling, assigning, reconfiguring, and releasing resources for one or more subordinate entities. That is, for scheduled communication, subordinate entities utilize resources allocated by the scheduling entity.

Base stations are not the only entities that may function as a scheduling entity. That is, in some examples, a UE may function as a scheduling entity, scheduling resources for one or more subordinate entities (for example, one or more other UEs). In this example, the UE is functioning as a scheduling entity, and other UEs utilize resources scheduled by the UE for wireless communication. A UE may function as a scheduling entity in a peer-to-peer (P2P) network, in a mesh network, or another type of network. In a mesh network example, UEs may optionally communicate directly with one another in addition to communicating with the scheduling entity.

Thus, in a RAN with a scheduled access to time—frequency resources and having a cellular configuration, a P2P configuration, and a mesh configuration, a scheduling entity and one or more subordinate entities may communicate utilizing the scheduled resources.

In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the UE 120 may perform scheduling operations, resource selection operations, as well as other operations described elsewhere herein as being performed by the base station 110.

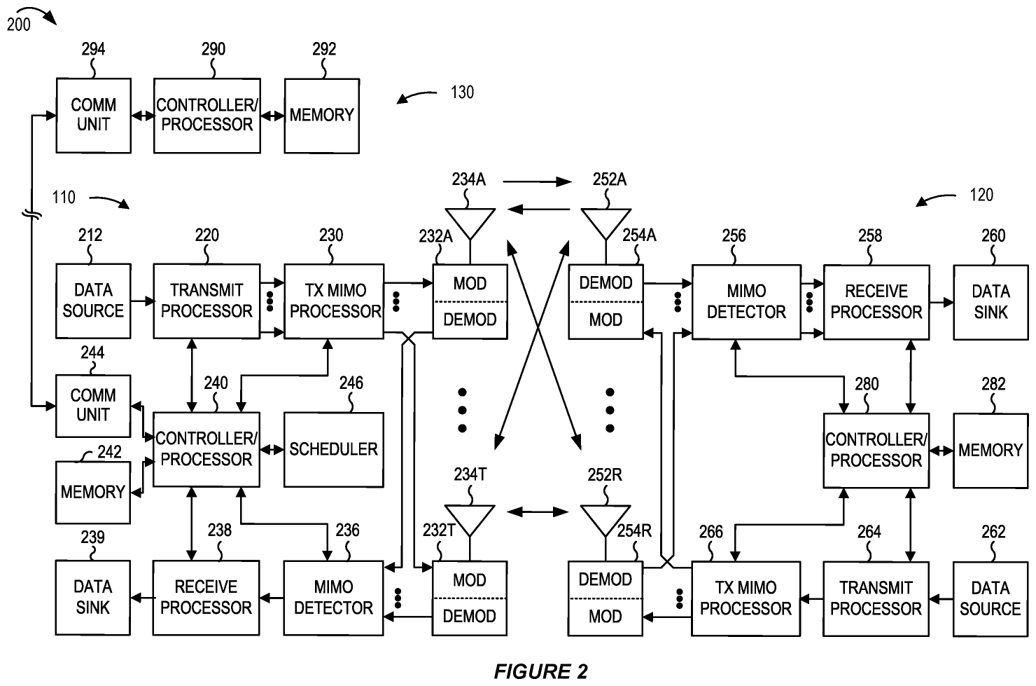

FIG. 2 is a block diagram conceptually illustrating an example 200 of a base station 110 in communication with a UE 120. In some aspects, the base station 110 and the UE 120 may respectively be one of the base stations and one of the UEs in wireless communication system 100 of FIG. 1. While the base station 110 may be described as a monolithic BS, in some implementations, the base station 110 may be a component of a disaggregated BS, such as a central unit (CU), a distributed unit (DU), or a radio unit (RU) implemented in a D-RAN or O-RAN configuration. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. The transmit processor 220 also may process system information (for example, for semi-static resource partitioning information (SRPI) or the like) and control information (for example, CQI requests, grants, upper layer signaling, among other examples.) and provide overhead symbols and control symbols. The transmit processor 220 also may generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide T output symbol streams to T modulators (MODs) 232a through 232t. Each modulator 232 may process a respective output symbol stream (for example, for OFDM) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for UE 120 to a data sink 260, and provide decoded control information and system information to a controller or processor (controller/processor) 280. A channel processor may determine RSRP, RSSI, RSRQ, channel quality indicator (CQI), among other examples. In some aspects, one or more components of UE 120 may be included in a housing.

On the uplink, at UE 120, a transmit processor 264 may receive and process data from a data source 262 and control information (for example, for reports including RSRP, RSSI, RSRQ, CQI, among other examples) from controller/processor 280. Transmit processor 264 also may generate reference symbols for one or more reference signals. The symbols from transmit processor 264 may be precoded by a TX MIMO processor 266 if applicable, further processed by modulators 254a through 254r (for example, for DFT-s-OFDM, CP-OFDM, among other examples), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to a controller or processor (i.e., controller/processor) 240. The base station 110 may include a communication unit 244 and may communicate to the network controller 130 via the communication unit 244. The network controller 130 may include a communication unit 294, a controller or processor (i.e., controller/processor) 290, and memory 292.

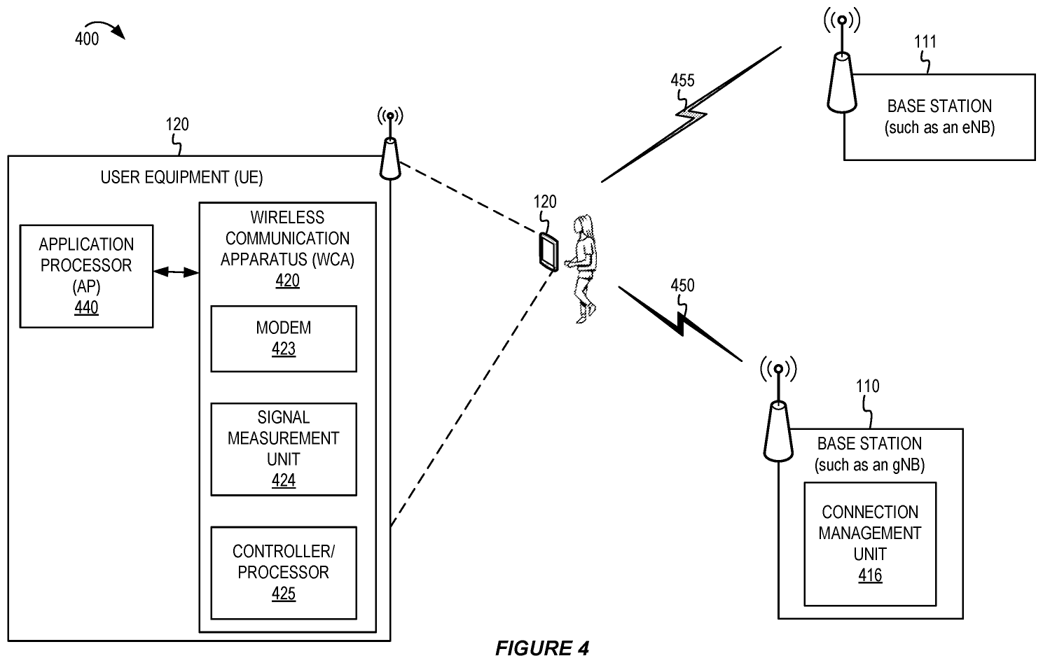

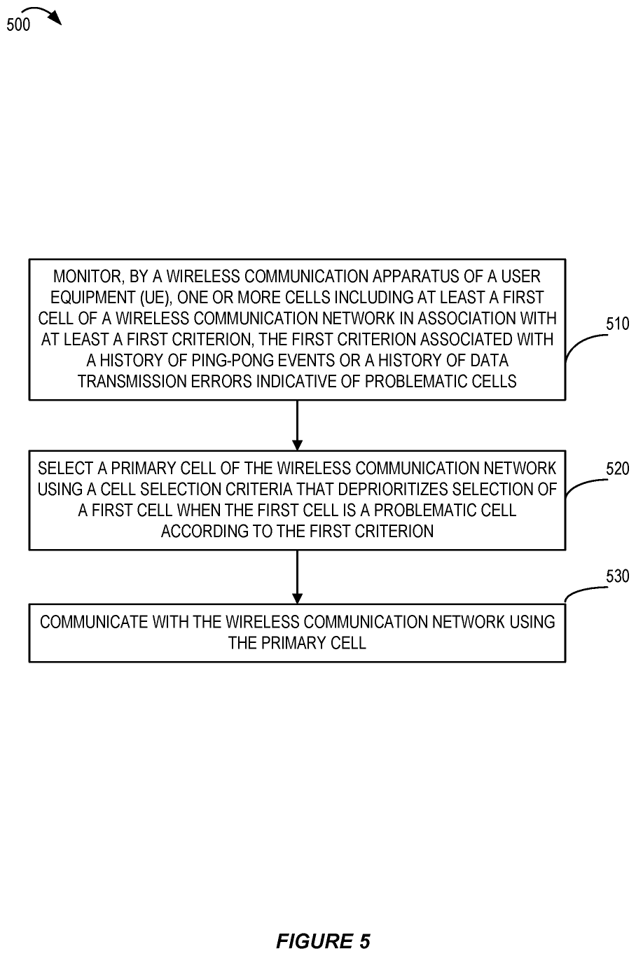

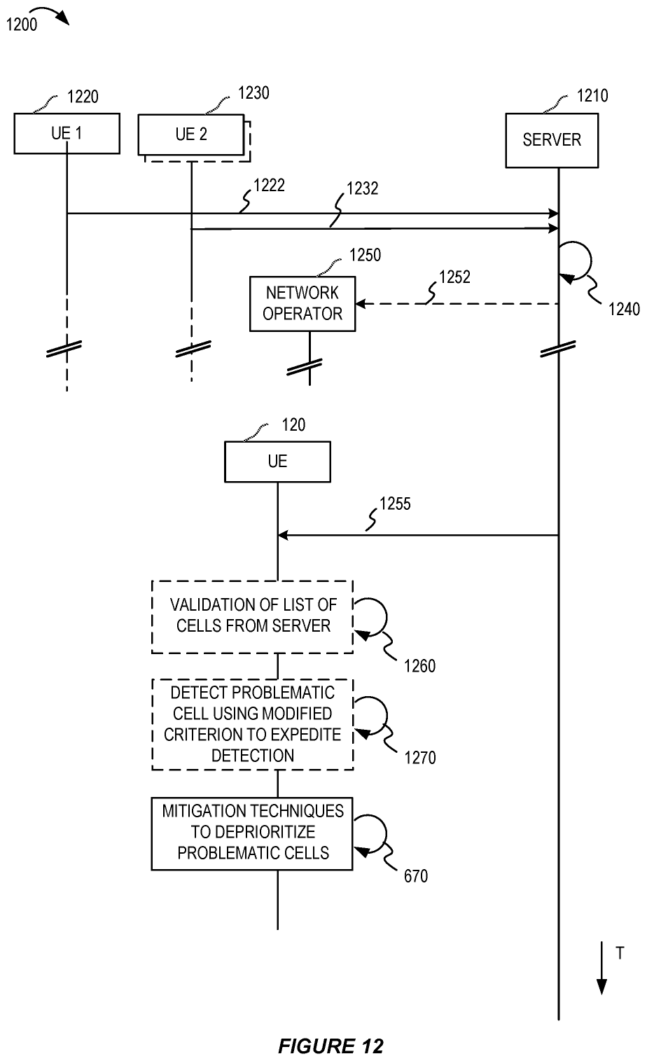

The controller/processor 240 of BS 110, the controller/processor 280 of UE 120, or any other component(s) of FIG. 2 may perform one or more techniques associated with cell selection, as described in more detail elsewhere herein. For example, the controller/processor 240 of BS 110, the controller/processor 280 of UE 120, or any other component(s) (or combinations of components) of FIG. 2 may perform or direct operations of, for example, any of the processes 500, 900, or 1000 described with reference to FIG. 5, 9, or 10, respectively, or those described with reference to the UE 120 of FIGS. 4, 6, 7, 8, or those described with reference to the UEs 1220 and 1230 described with reference to FIG. 12, or any other processes described herein. The memories 242 and 282 may store data and program codes for BS 110 and UE 120, respectively. A scheduler 246 may schedule UEs for data transmission on the downlink, the uplink, or a combination thereof.

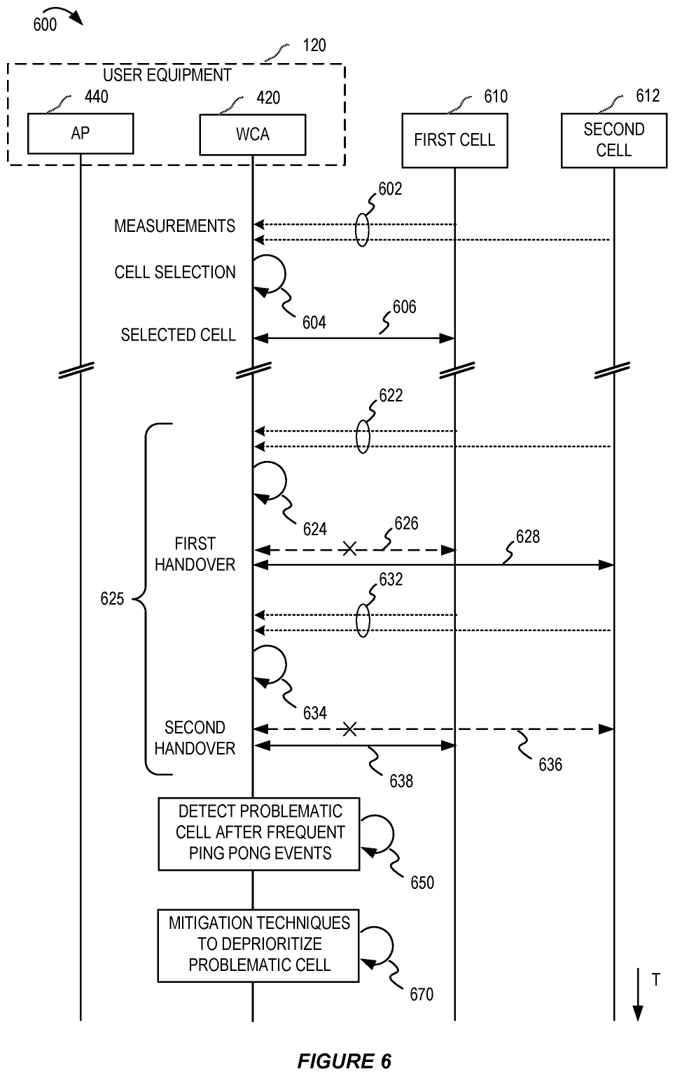

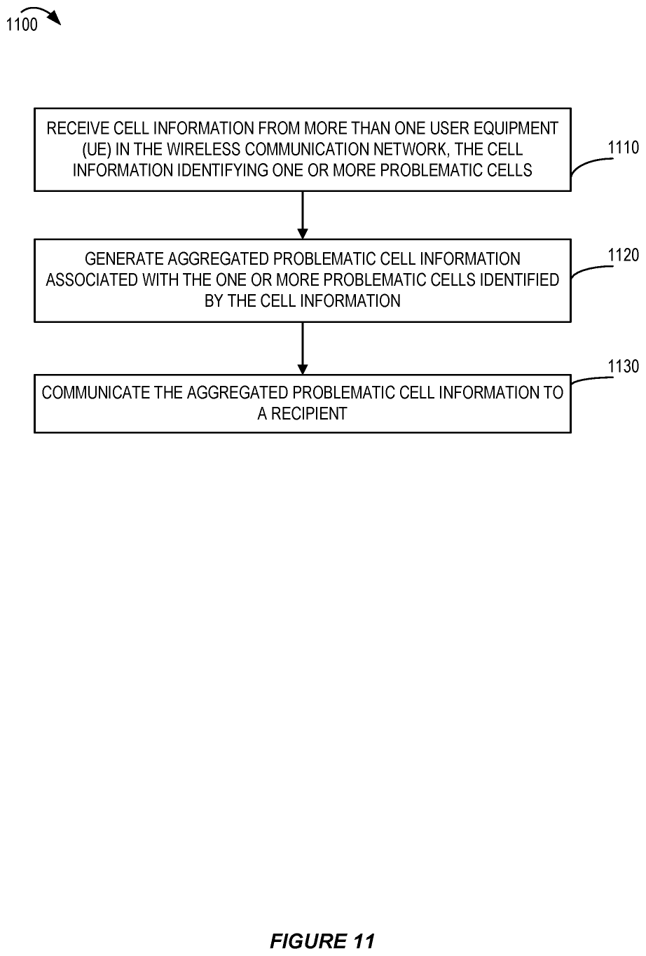

The stored program codes, when executed by the controller/processor 280 or other processors and modules at UE 120, may cause the UE 120 to perform operations described with reference to processes 500, 900, or 1000 of FIG. 5, 9, or 10, respectively, or those described with reference to the UE 120 of FIGS. 4, 6, 7, 8, or those described with reference to the UEs 1220 and 1230 described with reference to FIG. 12, or any other processes described herein. The stored program codes, when executed by the controller/processor 240 or other processors and modules at BS 110, may cause the BS 110 to perform operations described with reference to the flowchart 1100 of FIG. 11, or with reference to the BSs 110, 110 of FIG. 4, or with reference to the first cell 610 or second cell 612 described with reference to FIG. 6, 7, or 8, or other processes as described herein. A scheduler 246 may schedule UEs for data transmission on the downlink, the uplink, or a combination thereof.

In some aspects, UE 120 may include means for performing the any of the processes 500, 900, or 1000 described with reference to FIG. 5, 9, or 10, respectively, or those described with reference to the UE 120 of FIGS. 4, 6, 7, 8, or those described with reference to the UEs 1220 and 1230 described with reference to FIG. 12, or any other processes described herein. In some aspects, such means may include one or more components of UE 120 described in connection with FIG. 2. In some aspects, BS 110 may include means for performing the process described with reference to the flowchart 1100 of FIG. 11, or with reference to the BSs 110, 110 of FIG. 4, or with reference to the first cell 610 or second cell 612 described with reference to FIG. 6, 7, or 8, or other processes as described herein. In some aspects, such means may include one or more components of BS 110 described in connection with FIG. 2.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, the TX MIMO processor 266, or another processor may be performed by or under the control of controller/processor 280.

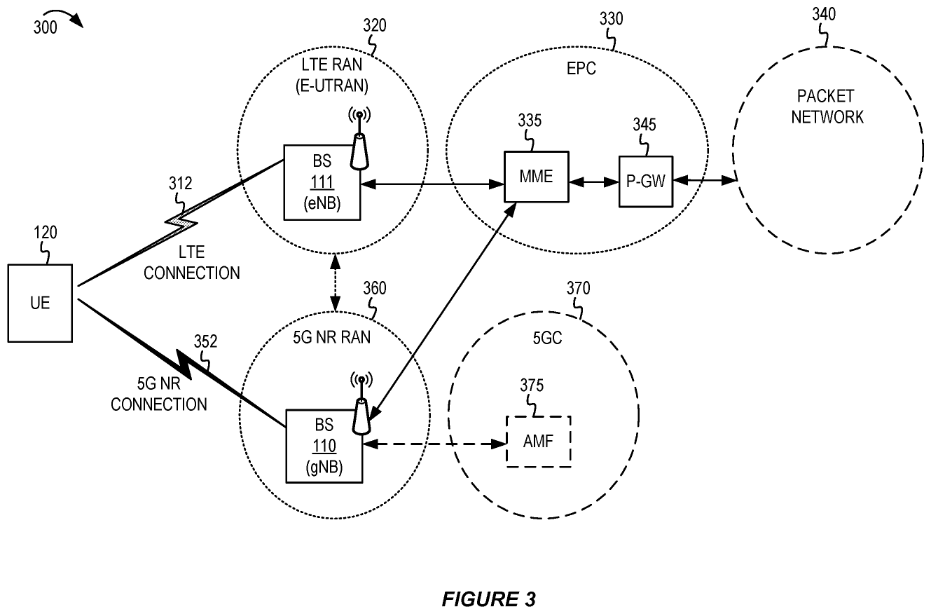

FIG. 3 shows a block diagram conceptually illustrating an example wireless communication system 300 in which a UE may perform cell selection. The wireless communication system 300 may include a UE 120, an LTE radio access network (RAN) 320, a 5G NR RAN 360, an Evolved Packet Core (EPC) 330, and a packet network 340. One or more LTE base stations may make up an LTE radio access network (RAN). The LTE RAN (sometimes also referred to as an LTE network) provides access to the wireless communication system. Similarly, one or more 5G base stations may make up a 5G New Radio (NR) RAN, and may be referred to as a 5G NR network that provides access to the wireless communication system. The LTE network and 5G NR network may be two examples of a radio access network that can be used to communicate to a core network of the wireless communication system. The wireless communication system 300 may be part of a WWAN, such as the wireless communication network 100 of FIG. 1. Although LTE RAN and 5G NR RAN are described with reference to FIG. 3, the same concepts may apply to disaggregated RAN (D-RAN) or open RAN (O-RAN) architectures, which may include one or more disaggregated constituent components, such as a central unit (CU), distributed unit (DU), and a radio unit (RU).

The UE 120 may include components (not shown), such a wireless communication apparatus (including a modem) and an application processor, among other examples, as shown in FIG. 4. In some implementations, one or more chips or components of the UE 120 may include the wireless communication apparatus and the application processor, and may communicate via one or more radio components of the UE 120. The communication unit may be capable of establishing an LTE connection (anchor connection) with a BS 111 (such as an eNB) of the LTE RAN 320 and establishing a 5G NR connection (secondary connection) with a BS 110 (such as a gNB) of the 5G NR RAN 360. For brevity, the description refers to the UE 120 making these connections. The UE 120 may refer to a portable electronic device or to one or more components of the portable electronic device.

The LTE RAN 320 may be an evolved universal terrestrial radio access network (E-UTRAN) and is just one example RAT that may be used for an access stratum of the wireless communication system 300. The EPC 330 is just one example of a core network that may be used in a non-access stratum of the wireless communication system 300. The 5G NR RAN 360 may use the same EPC 330 as the LTE RAN 320. Alternatively, the 5G NR RAN 360 may use a 5G Core (5GC) 370 with a 5G Core Access and Mobility Management Function (AMF) that performs similar functionality as the Mobility Management Entity (MME) 335 of the EPC 330. The 5GC 370 may connect to the packet network 340. In some deployments, the same packet network 340 may provide access to services such as Internet access, an IP multimedia subsystem (IMS) service, or other services. The example in FIG. 3 is described with reference to an E-UTRAN—NR dual connectivity (EN-DC) configuration in which the LTE RAN 320 and the NR RAN 360 utilize the same EPC 330 of the wireless communication system 300.

A wireless communication session or association between a user equipment (UE) and a base station (BS) may be referred to as a radio connection (or just a “connection”). A standalone access (SA) mode may refer to a connection in which the initial acquisition and connection are made between the UE and the RAN. A non-standalone access (NSA) mode may refer to the use of multiple connections that include a primary connection to a first base station and a secondary connection to a second base station. A radio resource control (RRC) configuration for a connection may include information about the serving cells of the BS for the UE to use. When it becomes necessary to change the RRC configuration, a base station may send an RRC Connection Reconfiguration message. Reasons to change the RRC configuration may include a handover or change to a neighbor cell (such as another cell of the same base station or another cell of a different base station).

A UE may initially camp on a first cell to register with the wireless communication network. For example, the UE may perform a tracking area registration, so the wireless communication system knows which tracking area to page the UE for mobile terminated (MT) communications. A UE is said to be camped on a cell when the UE has registered with the wireless communication and established a basic RRC relationship with the cell so that the cell is available for mobile originated (MO) or mobile terminated (MT) communication between the UE and the cell. A UE may have different RRC states depending on its connection with a base station. For example, the UE may be in an RRC connected (RRC CONNECTED) state (also referred to as “connected state” for brevity), an RRC idle (RRC IDLE) state (also referred to as “idle state” for brevity), or an RRC inactive (RRC INACTIVE) state (also referred to as “inactive state” for brevity). In the connected state, the UE may have an active radio connection with the base station and the base station may control mobility of the UE by managing handovers of the UE between neighboring cells. The UE may participate in mobility management by transmitting measurement reports that trigger a handover to a neighbor cell. In the idle state and inactive state, the UE may manage its mobility and may perform a cell reselection to camp on a different cell when the UE determines that a neighbor cell would be more suitable. The idle state refers to a state in which the UE may monitor for paging messages or short messages but does not have an access stratum (AS) registration with the network. The inactive state refers to a state in which the UE has an AS registration with the network and periodically updates the AS registration when it changes a tracking area. In both the idle state and inactive state, the UE may measure signal strength or signal quality of frequencies in neighboring cells to determine whether to perform a cell reselection.

Using EN-DC, the LTE RAN 320 and the 5G NR RAN 360 may be used to establish multiple wireless connections with the same UE 120. The UE 120 may establish a first wireless connection (such as the LTE connection 312) with the BS 111 of the LTE RAN 320.

Establishing the first wireless connection may include the UE 120 sending an RRC Setup Request message to the BS 111 (such as an eNB) and receiving an RRC Setup message from the BS 111. Once the LTE connection 312 is connected, the UE may setup a default packet bearer to the EPC 330. For example, the UE 120 may send an attach request message to the MME 335 in the EPC 330. The MME 335 may respond with an attach accept message that sets up the default packet bearer. The default packet bearer may be used to communicate with the MME 335 or other elements in the EPC 330. The default packet bearer may be used to setup other bearers or services provided by the wireless communication system 300. For example, the UE may send packet data via the default packet bearer to a data packet gateway (P-GW) 345 in the EPC 330 that connects to the packet network 340.

In some implementations, the BS 110 and the BS 111 may have an NSA architecture and may be configured to operate in an EN-DC mode (which also may be referred to as an NSA EN-DC mode or an NSA mode). After establishing the LTE connection 312, the UE 120 may establish a second wireless connection (such as the 5G NR connection 352) with the BS 110 (such as a gNB) of the 5G NR RAN 360. The second wireless connection may be established by the wireless communication system 300. For example, the BS 111 may determine that the UE 120 supports an EN-DC mode and may activate a bearer via the BS 110. The BS 111 may send an RRC Connection Reconfiguration message to the UE 120 to inform the UE 120 of the second wireless connection. Thereafter, the UE 120 may be in an EN-DC mode that includes wireless connections to both the BS 111 (such as an eNB) and the BS 110 (such as a gNB). While operating in the EN-DC mode, the BS 111 may be referred to as a master node (MN), and the BS 110 may be referred to as a secondary node (SN).

Each BS (such as BS 110 and BS 111) may operate multiple cells. In some traditional deployments, a BS may operate three (3) cells, but other quantities of cells may be deployed at a BS. A master cell group (MCG) may include a primary cell (PCell) and zero or more secondary cells (SCells) of the BS 111. A secondary cell group (SCG) may include a primary SCG cell (PSCell) and zero or more secondary cells (SCells) of the BS 110. Once an SCG is added to the RRC configuration, the UE 120 may be in an NSA EN-DC mode of operation. Any of cells within the MCG or SCG may be referred to as a serving cell. For Dual Connectivity operation, the term Special Cell (SpCell) may be the serving cell and may refer to the PCell of the MCG or the PSCell of the SCG.

Once the UE 120 is in the connected state, the UE 120 may perform serving cell and neighbor cell measurements (which may be referred to as signal quality measurements). The UE 120 may determine whether to generate and transmit a handover measurement report based on the serving cell and neighbor cell measurements, as described further in FIG. 4. The premise of the handover measurement reports is for the UE 120 to inform the BS 110 or the BS 111 when a neighbor cell may provide a better service for the UE 120. In response, the BS 110 or the BS 111 may perform a handover from the serving cell to the neighbor cell. The handover may include some network-side reconfiguration, such as transferring bearers and changing a registration status of the UE 120, as well as UE-to-network reconfiguration, such as the BS 110 or the BS 111 sending an RRC Connection Reconfiguration message to the UE 120. The RRC Connection Reconfiguration message may include changes to the MCG or SCG as part of the handover.

Often, a UE 120 may be within overlapping coverage areas of different cells of a BS or of different BSs. When the signal strengths of a neighbor cell and a serving cell are similar (such as within 2-3 dB, or 1-5 dB, etc.), it is possible for the UE 120 to experience repetitive triggered handover measurement reports, which may result in an undesirable ping-pong situation with frequent handovers between two or more cells.

The LTE RAN 320 may be an evolved universal terrestrial radio access network (E-UTRAN) and is just one example RAT that may be used for an access stratum of the wireless communication system 300. The EPC 330 is just one example of a core network that may be used in a non-access stratum of the wireless communication system 300. The 5G NR RAN 360 may use the same EPC 330 as the LTE RAN 320. Alternatively, the 5G NR RAN 360 may use a 5G Core (5GC) 370 with a 5G Core Access and Mobility Management Function (AMF) that performs similar functionality as the Mobility Management Entity (MME) 335 of the EPC 330. The 5GC 370 may connect to the packet network 340. In some deployments, the same packet network 340 may provide access to services such as Internet access, an IP multimedia subsystem (IMS) service, or other services.

FIG. 4 shows a pictorial diagram conceptually illustrating example mobility management techniques of a UE 120 in a wireless communication system. The wireless communication system 400 shown in FIG. 4 may be based on the example wireless communication system 300 described in FIG. 3. The wireless communication system 400 may be part of a WWAN, such as the wireless communication network 100 of FIG. 1. The wireless communication system 400 may include the UE 120, a BS 110 of a 5G NR network, and a BS 111 of an LTE network. As mentioned herein, in some implementations, the BS 110, the BS 111, or both, may be configured as a component of a D-RAN or O-RAN configuration, such as a disaggregated BS. The UE 120 may be an example implementation of the UEs shown in FIGS. 1 and 2. The BS 110 and the BS 111 may each be an example implementation of the BSs shown in FIGS. 1 and 2. Although not shown for simplicity, the wireless communication system 400 may include one or more additional BSs and one or more additional UEs. In some implementations, the BS 110 may be a gNB that may implement a 5G NR RAT described in this disclosure to manage communications of a 5G NR network. In some implementations, the BS 111 may be an eNB that may implement an LTE RAT described in this disclosure to manage communications of an LTE network. In some implementations, the BS 110 and the BS 111 may have an NSA architecture and may be configured to operate in an EN-DC mode, as described with reference to FIG. 3. The EN-DC mode also may be referred to as an NSA EN-DC mode or an NSA mode. While operating in the EN-DC mode, the BS 111 may be configured to operate as a MN and the BS 110 may be configured to operate as a SN, as described with reference to FIG. 3. In some implementations, a gNB that is configured to operate in an EN-DC mode (such as the BS 110) may be referred to as an en-gNB.

In some implementations, the UE 120 may include a wireless communication apparatus (WCA) 420 and an application processor 440. The wireless communication apparatus 420 may be configured to implement wireless communications using one or more WWAN RATs, such as an LTE RAT and a 5G NR RAT. The wireless communication apparatus 420 may include a modem 423, a signal measurement unit 424, and a controller/processor 425. The modem 423 may be configured to process wireless communications received from the wireless communication system 400, and prepare wireless communications for transmission to the wireless communication system 400. In some implementations, the modem 423 may work in conjunction with the signal measurement unit 424 to perform signal quality measurements on received wireless signals. For example, the modem 423 may work in conjunction with the signal measurement unit 424 to perform signal quality measurements on 5G and LTE wireless signals (such as reference signals) received from the BS 110 and BS 111, respectively. The controller/processor 425 may be configured to perform operations to establish a wireless connection with a cell of a BS (such as the BS 110) of the wireless communication system 400. The controller/processor 425 may be an example of the controller/processor 280 described with reference to FIG. 2. The controller/processor 425 may perform cell selection in conjunction with the signal measurement unit 424. For example, the cell selection may be used during an idle state of the UE reselect a new cell. In other examples, the cell selection may be used during a connected state of the UE to determine whether to trigger a handover. In some implementations, the controller/processor 425 may deprioritize selection of problematic cells in order to prevent excessive cell reselections or handovers or to avoid a problematic cell associated with data transmission errors, as further described herein. The application processor 440 may be configured to execute one or more applications of the UE 120.

In some implementations, the BS 110 may include a connection management unit 416. Although not shown for simplicity, the BS 111 also may include a connection management unit. The connection management unit 416 may perform operations to establish a wireless connection with one or more UEs of the wireless communication system 400 (such as the UE 120), and may manage the wireless connections, such as to determine whether to maintain the wireless connections or whether to handoff one or more of the UEs to another BS.

In some implementations, while operating in an EN-DC mode, the UE 120 may establish a wireless connection (which may be referred to as a 5G NR connection 450) with the BS 110 to obtain 5G NR service, and may establish a wireless connection (which may be referred to as an LTE connection 455) with a BS 111 to obtain LTE service. In some implementations, the UE 120 may establish the 5G NR connection 450 with one of the cells of the BS 110 (which may be referred to as a 5G serving cell), and may establish the LTE connection 455 with one of the cells of the BS 111 (which may be referred to as an LTE serving cell).

In some implementations, while operating in an EN-DC mode, the UE 120 may perform signal quality measurements on signals received from the 5G serving cell of the BS 110 and on signals received from one or more neighbor cells (which may be referred to as 5G neighbor cells). The signal quality measurements may be used by the UE 120, for example, to determine whether or not to transmit a handover measurement report to the BS 110. The one or more 5G neighbor cells may be one or more additional cells of the BS 110, or may be one or more cells of a different BS of the WWAN. If the UE 120 determines to generate and transmit a handover measurement report, the BS 110 may use the signal quality measurements included in the handover measurement report to initiate a handover of the UE 120 from the 5G serving cell to one of the 5G neighbor cells. If the UE 120 does not generate and transmit a handover measurement report, the UE 120 may continue to perform signal quality measurements and the UE 120 may remain connected to the 5G serving cell. In some implementations, the signal quality measurements may be reference signal received power (RSRP) measurements, reference signal received quality (RSRQ) measurements, or signal-to-interference-plus-noise ratio (SINR) measurements.

In some implementations, either or both of the BS 111 or the BS 110 may provide a measurement configuration to the UE 120 in an RRC message. The measurement configuration may include reporting criterion for triggering a measurement reporting event based on a signal measurement of a neighbor cell. Several types of standard measurement reports are defined by the 3GPP 38.331 technical standard. Some of the measurement reporting events are described in several examples of this disclosure, such as the Event A3, Event A4, Event A5, Event B1, and Event B2. A measurement reporting event occurs when a corresponding reporting criterion is satisfied for a time period. For example, Event A3 triggers a measurement report when a neighbor cell becomes better (such as stronger signal strength or higher signal quality) than the SpCell by at least an offset amount. Event A4 triggers a measurement report when a neighbor cell becomes better (such as stronger signal strength or higher signal quality) than a threshold. Event A5 triggers a measurement report when the SpCell becomes worse (such as weaker signal strength or lower signal quality) than a first threshold (threshold1) and a neighbor cell becomes better (such as stronger signal strength or higher signal quality) than a second threshold (threshold2). Event B1 triggers a measurement report when a neighboring inter-RAT cell becomes better than a threshold. Event B2 triggers a measurement report when the serving cell becomes worse than threshold1 while a neighboring inter-RAT cell becomes better than threshold2.

For the purpose of these measurement reporting events, the SpCell may be the PCell or the PSCell. The premise of these triggered measurement reports is for the UE 120 to inform the base station when a neighbor cell may provide a better service for the UE 120. In response, the base station may select the neighbor cell for connectivity to the wireless communication network. For example, in the connected state, the UE 120 may send a measurement report to trigger a handover to the neighbor cell. The handover may include some network-side reconfiguration, such as transferring bearers and changing a registration status of the UE 120, as well as UE-to-network reconfiguration, such as the BS 111 sending an RRC Connection Reconfiguration message to the UE 120. The RRC Connection Reconfiguration message may include changes to the MCG or SCG as part of the handover.

Referring back to FIG. 4, the UE 120 may periodically perform measurements of neighbor cells, such as other cells of BS 110 or of another BS 111. The measurements of the neighbor cells may be close (such as within 1-2 dB, 1-5 dB, etc.) to the measurement of the SpCell. The SpCell refers to either the PCell of the MCG or the PSCell of the SCG. Taking the SpCell of the SCG as an example, the UE 120 may compare the measurement results of the neighbor cell 452 of the BS 111 with the measurement results of the existing PSCell used for the 5G NR connection 352 with the BS 110. If the measurement of the neighbor cell 452 is greater than the measurement results of the PSCell, the Event A3 report may be triggered. The UE 120 may send the triggered Event A3 report to the BS 111, causing the BS 110 to reconfigure the RRC configuration to remove the serving cells of the BS 110 from the SCG and instead make the neighbor cell 452 of the BS 111 the PSCell of the updated SCG. Thus, the BS 110 may perform a handover from the BS 110 to the BS 111. While this procedure is normally desirable, what could happen is that soon after changing the RRC configuration to handover the 5G NR connection to the BS 111, the UE 120 may discover that the Event A3 report is triggered again—this time indicating that the BS 110 has a stronger measurement than the previous neighbor cell 452 (which has become the SpCell of the updated SCG). Thus, the UE 120 may send another Event A3 report (this time to the BS 111), causing the BS 111 to reconfigure the RRC again and perform a handover back to the BS 110.

The cycle may continue repetitively while the UE 120 remains in a location where the signals from neighbor cells (such as from both the BS 110 and the BS 111) have similar measurement results repetitively triggering the inequality (1) for the Event A3 report. Although the example of FIG. 4 is described with reference to Event A3, a similar ping-pong situation may occur with the inequalities associated with Event A4, Event A5, Event B1, or Event B2.

A ping-pong situation may be detected based on a pattern of reselections or handovers in a recent time period. For example, a history of ping-pong events may include Nx count of reselections or handovers events triggered within a time duration T. The UE 120 may detect a ping-pong situation when, for example, there are at least four (4) handovers or reselections between a common pair of cells within an approximately 20 second duration. When a ping-pong situation is detected by the UE 120, the UE 120 may use one or more techniques to suppress or further precondition the sending of triggered measurement reports. For example, the UE 120 may deprioritize selection of a problematic cell associated with a history of ping-pong events or may modify the thresholds associated with triggered measurement reports. In some implementations, when the UE 120 is already connected to a problematic cell, the cell selection procedure may be altered to reduce the likelihood that the UE 120 will perform a reselection or handover associated with the problematic cell or between a neighbor cell and the problematic cell.

FIG. 5 shows a flowchart illustrating an example process 500 for wireless communication by a UE. The operations of the process 500 may be implemented by a wireless communication apparatus, a UE, or any component thereof as described herein. In some implementations, the process 500 (or portions thereof) may be performed by a wireless communication apparatus of a UE, such the wireless communication apparatus 420, the wireless communication apparatus 1500, or the wireless communication apparatus 1615 described with reference to FIGS. 4, 6, 7, 8, 15, and 16, respectively. In some implementations, the process 500 may be performed by a UE or a component thereof, such as the UE 120, the UE 1220, the UE 1230, or the mobile communication device 1604 described with reference to any of FIGS. 1, 2, 3, 4, 6, 7, 8, 12, and 16, respectively. For brevity, the example process 500 is described as being performed by an apparatus that could be any of the above indicated UEs, wireless communication apparatus, mobile communication device, or a component thereof.

At block 510, the apparatus may monitor one or more cells including at least a first cell of a wireless communication network in association with at least a first criterion. The first criterion may be associated with a history of ping-pong events or a history of data transmission errors indicative of problematic cells.

At block 520, the apparatus may select a primary cell of the wireless communication network using a cell selection criteria that deprioritizes selection of a first cell when the first cell is a problematic cell according to the first criterion.

At block 530, the apparatus may communicate with the wireless communication network using the primary cell.

FIG. 6 shows a timing diagram 600 illustrating cell selection and an example technique for detecting a problematic cell. A UE may include an AP 440 and a WCA 420. Also shown in FIG. 6 is a first cell 610 and a second cell 620. For example, the first cell 610 may be an example of a cell provided by any of the BSs described herein. The second cell 620 may be an example of a neighbor cell provided by that same BS or another BS.

The WCA 420 may obtain signal measurements 602 from the first cell 610 and the second cell 620. At block 604, the WCA 420 perform a cell selection based on the signal measurements 602. For example, the WCA 420 may select the cell having the highest signal strength or priority. In some implementations, if the WCA 420 already has a list of problematic cells, the WCA 420 may deprioritize selection of cells in the list of problematic cells. The list of problematic cells may include identifiers of particular cells. For example, identifiers may include a cell global identity (CGI), a radio access technology (RAT) identifier, a physical cell identifier (PCI), an absolute radio frequency channel number (ARFCN), or any combination thereof. Alternatively, or additionally, the list of problematic cells may include location data indicating a location of a cluster of problematic cells. For purposes of the examples described with reference to FIGS. 6, 7, 8, and 9, the description of each example detection technique assumes that neither the first cell 610 nor the second cell 612 are initially identified as a problematic cell. In the first cell selection described with reference to FIG. 6, the WCA 420 selects the first cell 610. The cell selection may be repeated periodically while the WCA 420 is in the idle state. In some implementations, the WCA 420 may detect a problematic cell based on a history of ping-pong events. In the idle state, the WCA 420 may detect a ping-pong event when a plurality of cell selections result in alternatively selecting the first cell 610 and the second cell 612. For example, a first cell selection may result in selection of the first cell 610, a second cell selection (not shown) may result in selection of the second cell 612, and a third cell selection (not shown) may result in selection of the first cell 610 again. After a threshold quantity of ping-pong events associated with the first cell 610 and the second cell 612, the WCA 420 may identify the first cell 610 or the second cell 612 (or both) as a problematic cell.

At some point, the WCA 420 may transition to a connected state and establish an initial connection 606 to the wireless communication network. Periodically, the WCA 420 may obtain signal measurements and monitor cells for potential cell reselection or handover. For example, shown in FIG. 6, the WCA 420 may obtain signal measurements 622 and perform a cell reselection 624 in which the second cell 612 is selected. The signal measurements for the second cell 612 may match a measurement reporting event that triggers a first handover from the first cell 610 to the second cell 612. As part of the first handover, the WCA 420 may disconnect the connection 626 to the first cell 610 and establish a connection 628 to the second cell 612. Later, the WCA 420 may again obtain signal measurements 632 and perform a cell reselection 634 that results in a second handover—this time from the second cell 612 back to the first cell 610. In the connected state, the WCA 420 may detect a ping-pong event 625 based on a combination of the first handover and the second handover.

FIG. 6 shows a single ping-pong event 625. However, there may be additional ping-pong events (not shown). A high quantity of ping pong events (such as more than Nx ping-pong events) within a time period T may be indicative of a problematic cell. In this example, the second cell 612 may be considered a problematic cell with relation to the first cell 610. At block 650, the WCA 420 may determine that the second cell 612 is a problematic cell after frequent ping pong events (above a threshold quantity during a preceding time period). For example, the WCA 420 may add identification information for the second cell 612 to a list of problematic cells. In some implementations, the list of problematic cells may include a timestamp when the problematic cell was detected so that the problematic cell can be removed from the list after the timestamp is older than a threshold amount of time. In some implementations, the list of problematic cells also may indicate the pair of cells which are associated with the ping pong event such that the second cell 612 is considered a problematic cell when the WCA 420 is connected to the first cell 610 but may not be considered a problematic cell when the WCA 420 is connected to a different cell (not shown).

At block 670, the WCA 420 may implement mitigation techniques to deprioritize selection of the problematic cell. Some example mitigation techniques (also referred to as deprioritizing) may include preventing selection of the deprioritize cell, adjusting the signal measurements associated with the problematic cell so that a triggered measurement reporting event is less likely to triggered, adjusting a threshold or offset condition associated with the triggered measurement reporting event so that the triggered measurement reporting event is less likely to be triggered, among other examples.

In one example mitigation technique (such as when the WCA 420 detects a history of ping-ping events based on reselections of the first cell 610 and the 612 in an idle state), the WCA 420 may adjust a reselection threshold for a reselection to the second cell 612 (as a problematic cell or in association with a problematic frequency of the second cell 612). For example, the WCA 420 may adjust the reselection threshold by a positive offset O₁ or decrease ranking in reselection by a negative offset O₁ as in the following equations.
ThresX,High/ThresX,Low+O₁ in the LTE and NR neighbor of higher or lower priority
Or Rn=Q_{meas,n}−Qoffset−Qoffsetₜₑₘₚ−O₁ in the LTE and NR neighbor of same priority

In another example mitigation technique (such as when the WCA 420 detects a history of ping-pong events based on handovers between the first cell 610 and the second cell 612 in a connected state), the WCA 420 may adjust an offset to make it more difficult to send a measurement report associated with triggering handover to the second cell 612 (as a problematic cell or in association with a problematic frequency of the second cell 612). For example, the WCA 420 may add a positive offset O₂ to increase the threshold for triggering reporting as in the following equations.
a3-Offset+O₂ (Neighbour becomes amount of offset better than PCell/PSCell)
a4-Offset+O₂ (Neighbour becomes better than absolute threshold)
a5-Threshold2+O₂ (PCell/PSCell becomes worse than absolute threshold1 AND Neighbour/SCell becomes better than another absolute threshold2)
b1-Threshold+O₂ (Inter-RAT Neighbour becomes better than absolute threshold)
b2-Threshold2+O₂ (PCell becomes worse than absolute threshold1 AND Inter-RAT Neighbour becomes better than another absolute threshold2)

In some cases, a ping pong may occur between an LTE cell and a NR cell. A measurement reporting event (Event B1) is associated with inter-RAT handover. Event B1 triggers a measurement report when a neighboring inter-RAT cell becomes better than a threshold (b1-Threshold). Event B2 triggers a measurement report when the serving cell becomes worse than threshold1 while a neighboring inter-RAT cell becomes better than threshold2. In some implementations, the mitigation technique may include overriding the measurement configuration to replace the B1 reporting event (configured by the network) with a B2 reporting event (configured by the WCA 420 as a replacement event configuration) such that the measurement reporting event is satisfied when a signal measurement of the first cell 610 is worse than a first B2 threshold (B2-Threshold1) and the signal measurement of the second cell 612 (problematic cell) is better than a second B2 threshold (B2-Threshold2).

In some implementations, the mitigation technique may include avoiding the problematic cell (such as a problematic cell identified by CGI) in the cell selection, such as during power up, coming out of airplane mode, or OOS recovery, unless there are no other suitable cells to select.

In some implementations, the problematic cell may be identified by RAT, PCI, ARFCN, or a combination thereof, and the mitigation technique may include deprioritizing the problematic cell in the cell reselection. For example, the problematic cell may be excluded from the cell selection (reselection)). Alternatively, the WCA 420 may apply a negative offset in the measurement: Srxlev−O₁ or Squal−O₂.

In some implementations, the problematic cell may be identified by RAT, PCI, ARFCN, or a combination thereof, and the mitigation technique may include reducing the occurrence of signal measurements of the problematic cell or refraining from communicating triggered measurement reports for the problematic cell. In some implementations, the WCA 420 may apply a negative offset in the measurement: rsrp−O₃, rsrq−O₄, sinr−O₅.

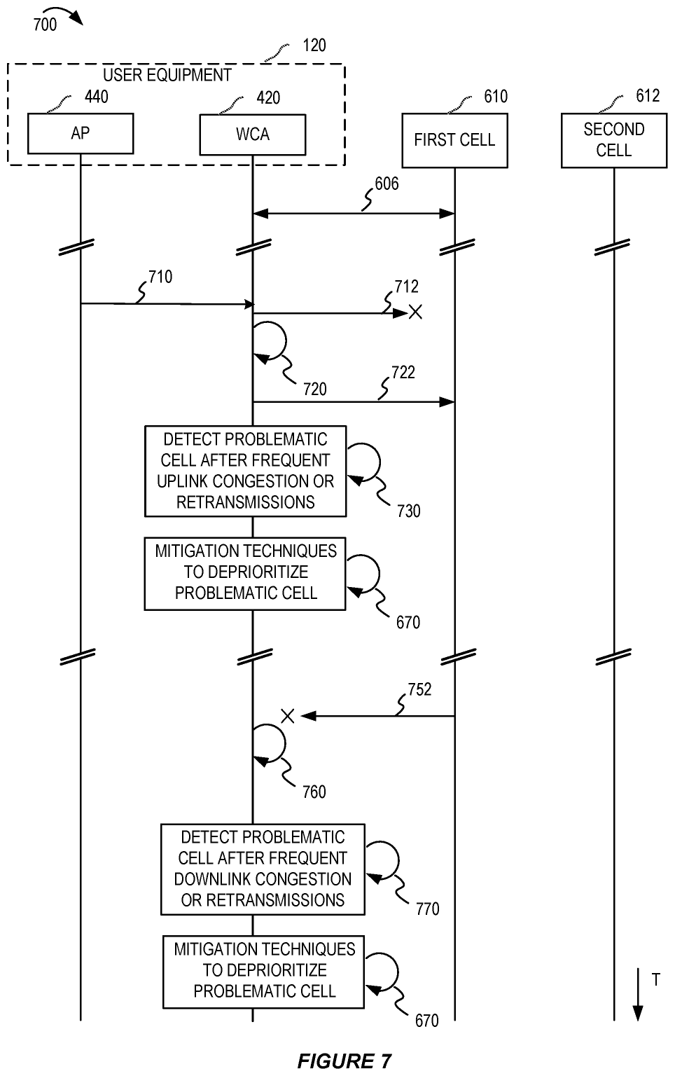

FIG. 7 shows a timing diagram 700 illustrating example techniques for detecting a problematic cell associated with a history of data transmission errors. As described with reference to FIG. 6, the WCA 420 of the UE 120 may have an initial connection 606 to the first cell 610. FIG. 7 includes examples of uplink and downlink data transmission errors that may be used as criterion to detect that the first cell 610 is a problematic cell.

In an example of uplink data transmission errors, the WCA 420 may receive application data from the AP 440 and attempt to transmit uplink data 712 to the first cell 610. However, the uplink data transmission 712 may experience an uplink transmission error. At block 720, the WCA 420 may buffer the uplink data and may attempt to transmit the buffered data 722 later. Alternatively, the first uplink data transmission 712 may be corrupt due to signal degradation or congestion and the data 722 may be a retransmission.

At block 730, the WCA 420 may determine that the first cell 610 is a problematic cell after frequent uplink congestion (such as frequent buffer events) or frequent retransmissions. As example, the uplink data transmission errors may be associated with a problematic cell when:
High UL PDCP buffer watermark more than N₁ times in last T seconds; or
UL data RLC retransmission reaches rlc-MaxNumRetx for more than N₂ times in last T sec.

At block 670, the WCA 420 may implement mitigation techniques to deprioritize the problematic cell (in this example, the first cell 610 is a problematic cell based on a history of data transmission errors). The mitigation techniques in block 670 may be similar to those described with reference to FIG. 6.

In an example of downlink data transmission errors, the WCA 420 may attempt to receive downlink data 752 from the first cell 610 and experience a downlink data transmission error (such as a corrupt transmission or out of sequence transmission). At block 760, the WCA 420 may request a retransmission or perform a reordering of downlink transmissions. At block 770, the WCA 420 may determine that the first cell 610 is a problematic cell after frequent downlink reordering timer expirations or frequent retransmissions. For example, downlink data transmission errors may be associated with a problematic cell when:
DL reordering timer T-reordering or reassembly timer T-Reassembly has expired more than N₃ times in last T sec.

At block 670, the WCA 420 may implement mitigation techniques to deprioritize the problematic cell (in this example, the first cell 610 is a problematic cell based on a history of data transmission errors). The mitigation techniques in block 670 may be similar to those described with reference to FIG. 6.

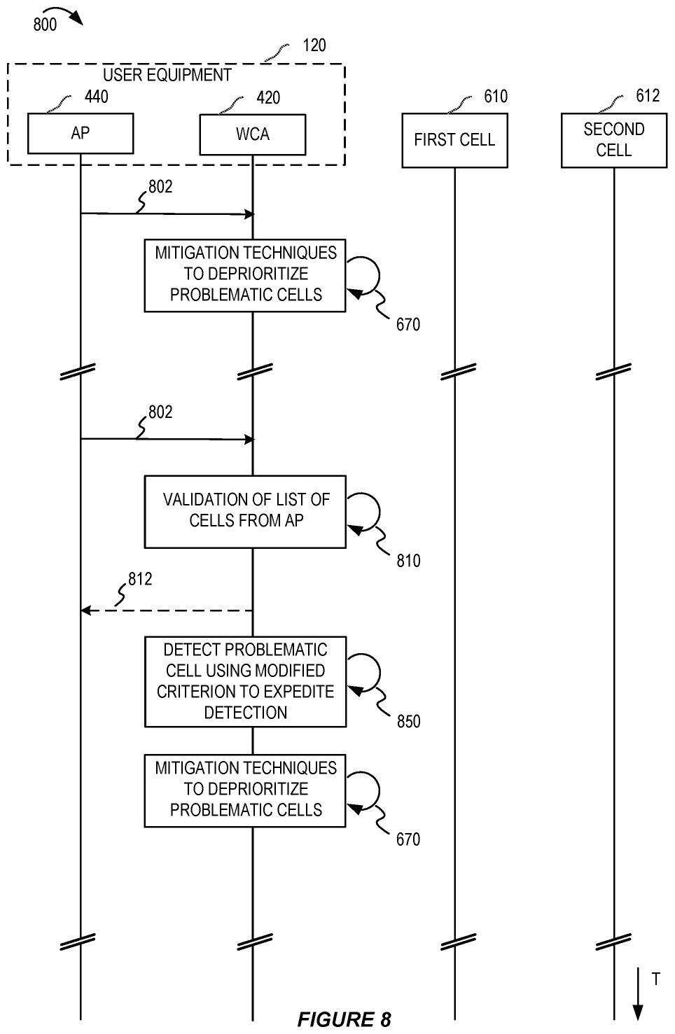

FIG. 8 shows a timing diagram 800 illustrating example techniques in which an AP of the UE provides identifications of one or more cells considered to be problematic cells by the AP. In a first example, the WCA 420 may receive a list 802 of cells that includes the identifications of one or more cells considered to be problematic cells by the AP. At block 670, the WCA 420 may implement mitigation techniques (such as those described with reference to FIG. 6) to deprioritize selection of problematic cells identified by the list 802 of cells from the AP 440.

In a second example, the WCA 420 may receive a list 802 of cells that includes the identifications of one or more cells considered to be problematic cells by the AP. At block 810, the WCA 420 may perform one or more operations to validate the list of cells. For example, the WCA 420 may cross reference the identified calls from the list with a list of problematic cells determined by the WCA 420.

In some implementations, the WCA 420 may provide a status 812 regarding one or more cells identified in the list 802 of cells. For example, the WCA 420 may indicate whether a particular cell is confirmed as a problematic cell by the wireless communication apparatus, being monitoring the cell as a potentially problematic cell, or not considered a problematic cell by the wireless communication apparatus.

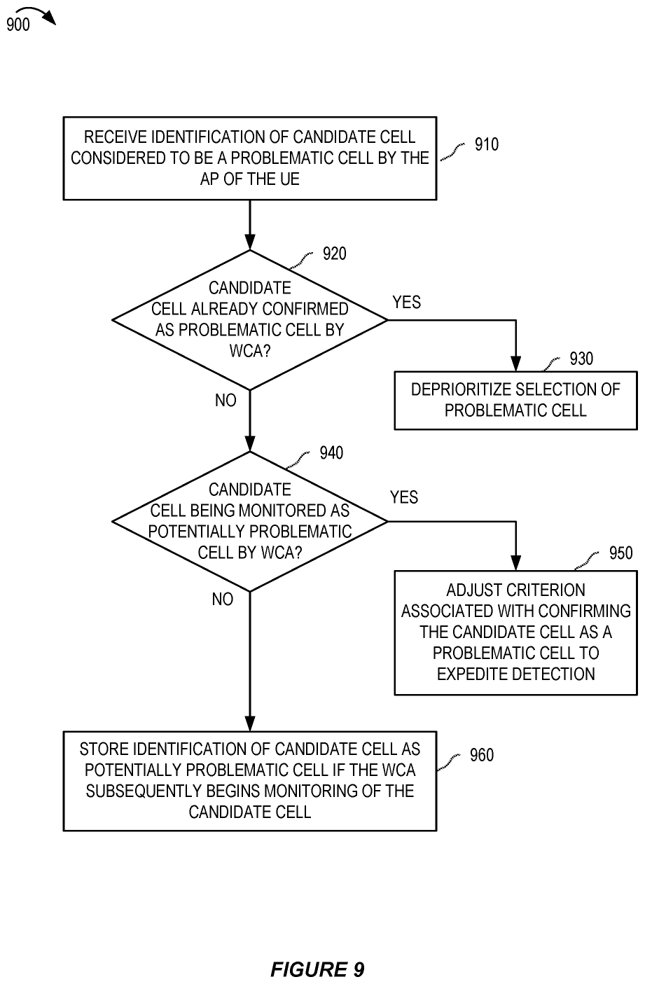

In some implementations, the WCA 420 may perform a process 900 such as that described with reference to FIG. 9 to expedite a determination that an identified cell is a problematic cell. In some implementations, the validation performed for block 810 may include modifying a criterion (such as reducing a threshold) by which a cell identified in the list 802 is confirmed by the WCA 420 to be a problematic cell. Thus, the modified criterion may expedite a determination that a particular cell is a problematic cell. At block 850, the WCA 420 may detect the problematic cell using the modified criterion.

At block 670, the WCA 420 may implement mitigation techniques (such as those described with reference to FIG. 6) to deprioritize selection of problematic cells identified by the list 802 of cells from the AP 440.

FIG. 9 shows a flowchart illustrating an example process 900 for a wireless communication apparatus of a UE to validate cell information received by an application processor of the UE. The operations of the process 500 may be implemented by a wireless communication apparatus, a UE, or any component thereof as described herein. In some implementations, the process 500 (or portions thereof) may be performed by a wireless communication apparatus of a UE, such the wireless communication apparatus 420, the wireless communication apparatus 1500, or the wireless communication apparatus 1615 described with reference to FIGS. 4, 6, 7, 8, 15, and 16, respectively. In some implementations, the process 900 may be performed by a UE or a component thereof, such as the UE 120, the UE 1220, the UE 1230, or the mobile communication device 1604 described with reference to any of FIGS. 1, 2, 3, 4, 6, 7, 8, 12, and 16, respectively. For brevity, the example process 900 is described as being performed by an apparatus that could be any of the above indicated UEs, wireless communication apparatus, mobile communication device, or a component thereof.

At block 910, the apparatus may receive an identification of a candidate cell considered to be a problematic cell by the AP of the UE.

At block 920, the apparatus may determine whether the candidate cell is already confirmed as a problematic cell by the wireless communication apparatus. If so, the process 900 proceeds to block 930. At block 930, the apparatus may deprioritize selection of the problematic cell. If the candidate cell is not yet confirmed as a problematic cell by the wireless communication apparatus, the process 900 proceeds to block 940.

At block 940, the apparatus may determine whether the candidate cell is being monitored as a potentially problematic cell by the wireless communication apparatus. If so, the process 900 proceeds to block 950. Otherwise, the process 900 proceeds to block 960.

At block 950, the apparatus may adjust a criterion associated with confirming the candidate cell as a problematic cell to expedite a determination whether the candidate cell is a problematic cell.

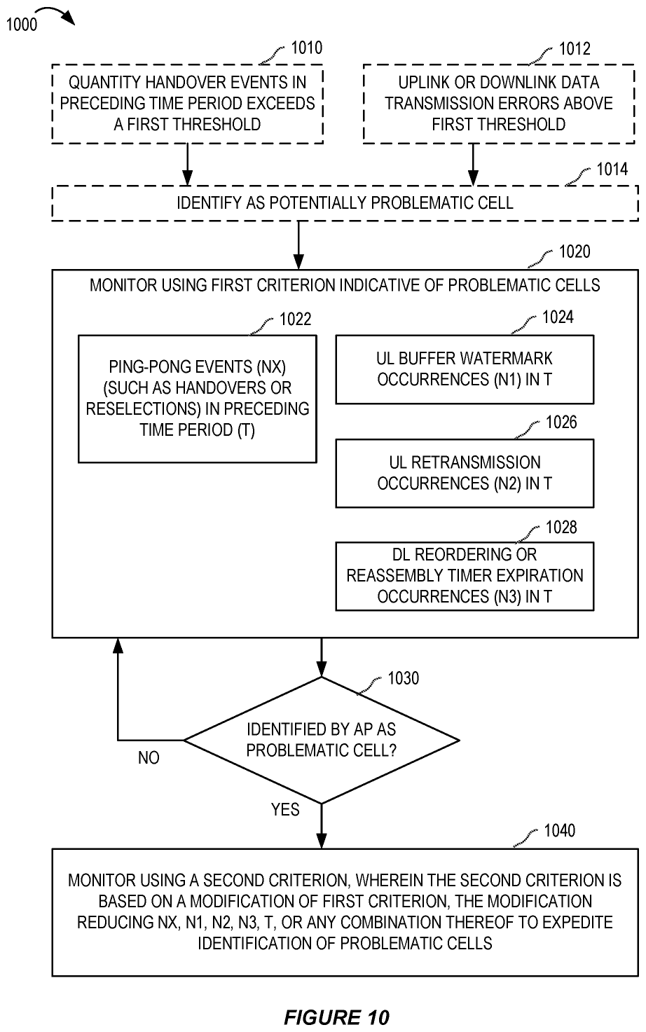

At block 960, the apparatus may store the identification of the candidate cell as a potentially problematic cell. If the wireless communication apparatus subsequently begins monitoring ping-pong events or data transmission errors associated with the candidate cell, the wireless communication apparatus may consider the candidate cell as potentially problematic cell and use the adjusted criterion as described with reference to block 950 and further described with reference to FIG. 10.

FIG. 10 shows a flowchart illustrating an example process 1000 for monitoring a cell using criteria indicative of problematic cells. The operations of the process 500 may be implemented by a wireless communication apparatus, a UE, or any component thereof as described herein. In some implementations, the process 500 (or portions thereof) may be performed by a wireless communication apparatus of a UE, such the wireless communication apparatus 420, the wireless communication apparatus 1500, or the wireless communication apparatus 1615 described with reference to FIGS. 4, 6, 7, 8, 15, and 16, respectively. In some implementations, the process 1000 may be performed by a UE or a component thereof, such as the UE 120, the UE 1220, the UE 1230, or the mobile communication device 1604 described with reference to any of FIGS. 1, 2, 3, 4, 6, 7, 8, 12, and 16, respectively. For brevity, the example process 1000 is described as being performed by an apparatus that could be any of the above indicated UEs, wireless communication apparatus, mobile communication device, or a component thereof.

Initially, the apparatus may monitor for a first threshold of ping-pong events or data transmissions to determine whether a particular cell is a potentially problematic cell. For example, at block 1010, the apparatus may determine that a quantity of ping-pong events (such as handovers or reselections involving a pair of cells) in a preceding time period exceeds a first threshold. Alternatively, or additionally, at block 1012, the apparatus may determine that a quantity of uplink or downlink data transmission errors in the preceding time period exceeds the first threshold. Upon determining that the first threshold is met, at block 1014, the apparatus may identify the cell as a potentially problematic cell that warrants further monitoring and confirmation as a problematic cell. Alternatively, the operations of blocks 1010, 1012 and 1014 may be omitted and the apparatus may monitor a cell without an interim designation as a potentially problematic cell.

At block 1020, the apparatus may monitor the cell using a first criterion indicative of problematic cells. FIG. 10 illustrates some examples of the first criterion. The examples are provided for pedagogical purposes and not intended as a complete list of criteria that may be used to detect a problematic cell. The example criteria include:
At block 1022: a quantity of ping-pong events (Nx) in a preceding time period (T).
At block 1024: a quantity of uplink buffer watermark occurrences (N1) in a preceding time period (T)
At block 1026: a quantity of uplink retransmission occurrences (N2) in a preceding time period (T)
At block 1028: a quantity of downlink reordering or reassembly timer expiration occurrences (N3) in a preceding time period (T)

At block 1030, the apparatus may determine whether the cell being monitored is also identified as a potentially problematic cell by the AP. If so, the process 1000 proceeds to block 1040. Otherwise, the process proceeds to block 1020 where the first criterion is used to determine whether the cell is a problematic cell.

At block 1040, the apparatus may monitor the cell using a second criterion indicative of problematic cells. The second criterion may be configured to expedite a determination whether the cell is confirmed as a problematic cell. The second criterion may be based on a modification of the first criterion, such as reducing the variables (Nx, N1, N2, N3, or T) of the first criterion.

FIG. 11 shows a flowchart illustrating an example process 1100 of a server for aggregating problematic cell information. The operations of the process 1100 may be implemented by a wireless communication apparatus, a UE, or any component thereof as described herein. In some implementations, the process 1100 (or portions thereof) may be performed by a server, such the server 1210 described with reference to FIG. 12, respectively. In some implementations, the process 1100 may be performed by a network controller or a component thereof, such as the network controller 130 described with reference to FIG. 2. For brevity, the example process 1100 is described as being performed by a server.

At block 1110, the server may receive cell information from more than one UE in the wireless communication network. The cell information may identify one or more problematic cells. For example, the cell information may include a cell global identity (CGI), a radio access technology (RAT) identifier, a physical cell identifier (PCI), an absolute radio frequency channel number (ARFCN), or any combination thereof. Alternatively, or additionally, the cell information may include location data for identifying one or more problematic cells based on location.

At block 1120, the server may generate aggregated problematic cell information associated with the one or more problematic cells identified by the cell information.

At block 1130, the server may communicate the aggregated problematic cell information to a recipient. For example, the recipient may be a UE, an application provider, a network operator, or an OEM entity.

FIG. 12 shows a timing diagram 1200 illustrating example techniques in which one or more UEs provide problematic cell information to a server configured to aggregate and redistribute problematic cell information. A server 1210 may include a communication unit (not shown) configured to receive problematic cell information from multiple UEs. For example, the server 1210 may receive problematic cell information 1222 and 1232 from a first UE 1220 and a second UE 1230, respectively. In some implementations, the problematic cell information may include identification information, such as the CGI, RAT, PCI, ARFCN, or any combination thereof. Alternatively, or additionally, the problematic cell information may include location data indicative of a geographic location of one or more problematic cells.

At block 1240, the server 1210 may aggregate the problematic cell information 1222 and 1232 to generate aggregated problematic cell information. In some aspects, the aggregation of problematic cell information also may be referred to as crowdsourcing since the problematic cell information comes from more than one UE. Furthermore, the problematic cell information 1222 and 1232 may come from any component of the UEs 1220 and 1230, such as the AP (not shown) or the wireless communication apparatus (not shown) of each of the UEs.

The server 1210 may be configured to transmit the aggregated problematic cell information to one or more recipients. For example, the server 1210 may transmit the aggregated problematic cell information 1252 to a network operator 1250 or application provider (not shown). The network operator 1250 may use the aggregated problematic cell information to modify one or more settings in a BS associated with a problematic cell. An application provider may communicate the aggregated problematic cell information to an AP (not shown) of a UE so that the AP can provide it to the wireless communication apparatus in the UE.

In some implementations, the server 1210 transmits the aggregated problematic cell information 1255 to a UE 120. At block 1260, the UE 120 may perform a validation of the list of cells from the server. For example, the operations of block 1260 may be similar to those described with reference to block 810 of FIG. 8, or the operations of processes 900 and 1000 described with reference to FIGS. 9 and 10, respectively, except that in block 1260, the list of cells comes from the server rather than an AP. At block 1270, the UE 120 may monitor the cells identified in the aggregated problematic cell information using a modified criterion to expedition detection of a problematic cell. For example, the operations at block 1270 may be similar to the operations described with reference to block 1040 of FIG. 10. At block 670, the UE 120 may implement mitigation techniques to deprioritize the problematic cells identified in the aggregated problematic cell information. The mitigation techniques in block 670 may be similar to those described with reference to FIG. 6.

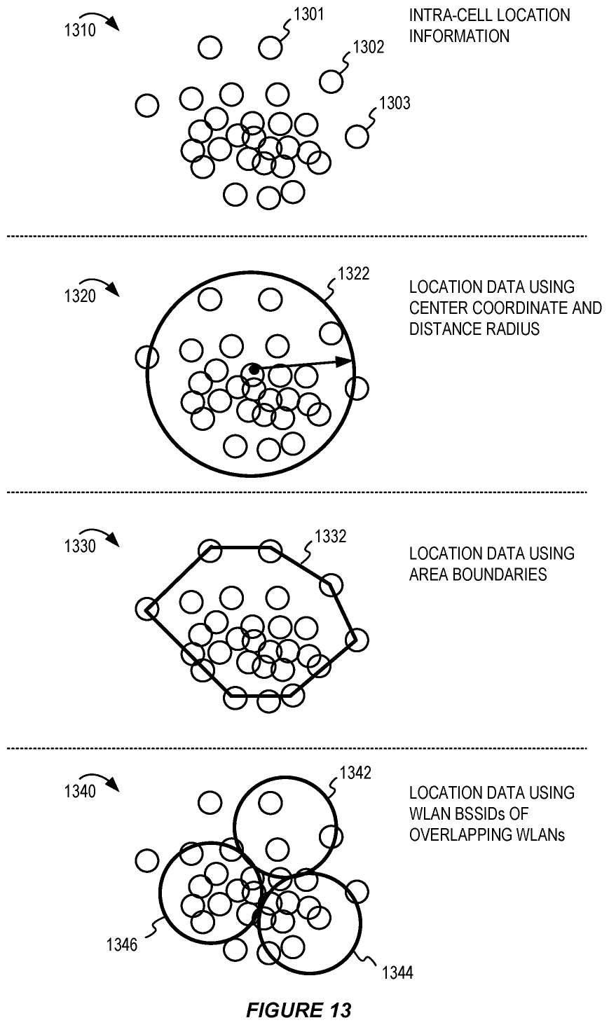

FIG. 13 shows a conceptual diagram 1300 illustrating example techniques in which location data may be used to identify areas of problematic cells. In some implementations, the location data may be used to identify problematic areas which can be smaller than a cell such that the cell is only considered a problematic cell when the wireless communication apparatus is within a problematic area. In a first example 1310, the location data may include intra-cell location information, such as a geographical coordinate, address, among other examples. The intra-cell location information may include location data of one or more problematic areas for one or more problematic cells (such as problematic cells 1301, 1302, and 1303).

In a second example 1320, the location data may include a central coordinate and a distance radius such that the location data defines a circular geographical area 1322 associated with problematic areas associated with a cluster of problematic cells. The UE (or the WCA of the UE) may determine a present location of the UE. When the present location of the UE is in the circular geographical area 1322, the UE (or the WCA) may implement mitigation techniques to avoid excessive handovers or reselection to the problematic cells while the UE (or WCA) is within the circular geographical area 1322 that includes problematic areas of one or more problematic cells.

In a third example 1320, the location data may include area boundaries such that the location data defines a polygonal area 1332 associated with problematic areas of a problematic cells. When the present location of the UE is in the polygonal area 1332, the UE (or the WCA) may implement mitigation techniques to avoid excessive handovers or reselections to the problematic cells in the problematic areas of problematic cells in the polygonal area 1332. The area boundaries may be defined based on street address, geographical coordinates, cell identifiers of cells at the vertices, or any location information that can be extrapolated to determine the polygonal area 1332.

In a fourth example 1340, the location data may include WLAN BSSIDs 1342, 1344, and 1346 of one or more WLANs that have coverage areas overlapping problematic areas associated with one or more problematic cells. When the UE detects a broadcast signal from a WLAN having one of the indicated WLAN BSSIDs 1342, 1344, or 1346, the UE may determine that it is in a coverage area associated with one of the indicated WLAN BSSIDs 1342, 1344, or 1346, the UE (or the WCA) may implement mitigation techniques to avoid excessive handovers or reselections to the problematic cells in the coverage area of the indicated WLAN BSSID.

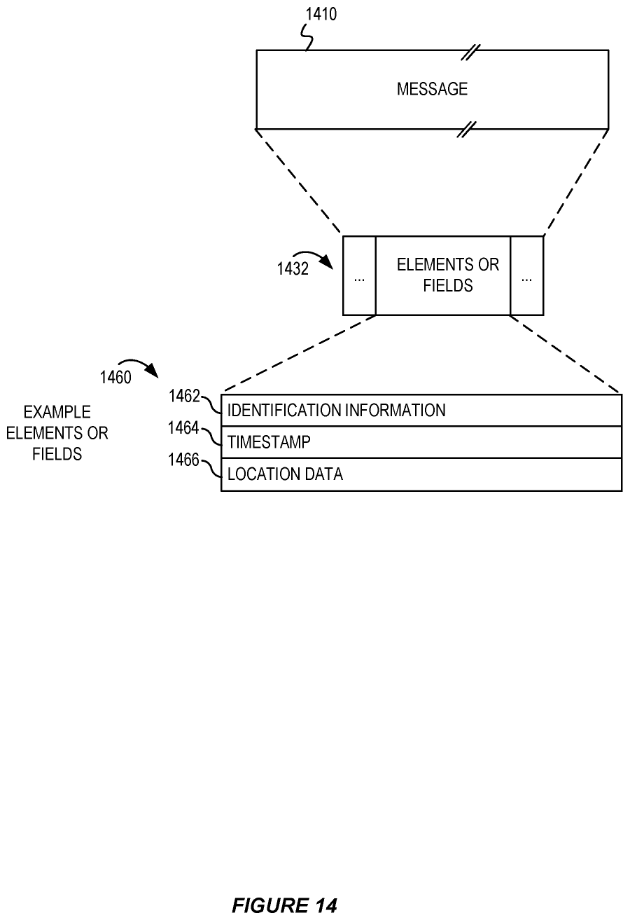

FIG. 14 shows a conceptual diagram of an example message 1410 according to some implementations. The message 1410 may be an example of cell information that a UE (or WCA) may transmit to a server or AP. Alternatively, the message 1410 may be an example of cell information that an AP transmits to a WCA of the UE. Alternatively, the message 1410 may be an example of aggregated problematic cell information that a server may transmit to a UE (or a WCA of a UE).

The message 1410 may include a variety of elements or fields 1432. FIG. 10 includes several example elements or fields 1460. In some implementations, the example elements or fields 1460 may include identification information 1462, a timestamp 1464, location data 1466, or any combination thereof.

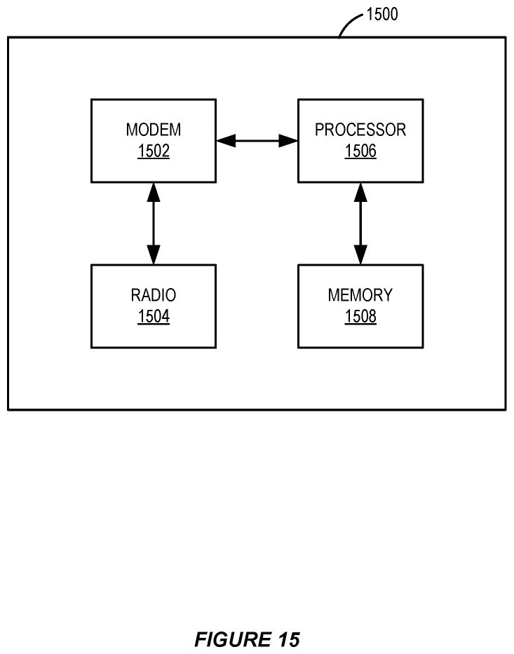

FIG. 15 shows a block diagram of an example wireless communication apparatus 1500. In some implementations, the wireless communication apparatus 1500 can be an example of a device for use in a UE, such as the UE 120 described with reference to any of the Figures herein. The wireless communication apparatus 1500 is capable of transmitting (or outputting for transmission) and receiving wireless communications.

The wireless communication apparatus 1500 can be, or can include, a chip, system on chip (SoC), chipset, package or device. The term “system-on-chip” (SoC) is used herein to refer to a set of interconnected electronic circuits typically, but not exclusively, including one or more processors, a memory, and a communication interface. The SoC may include a variety of different types of processors and processor cores, such as a general purpose processor, a central processing unit (CPU), a digital signal processor (DSP), a graphics processing unit (GPU), an accelerated processing unit (APU), a sub-system processor, an auxiliary processor, a single-core processor, and a multicore processor. The SoC may further include other hardware and hardware combinations, such as a field programmable gate array (FPGA), a configuration and status register (CSR), an application-specific integrated circuit (ASIC), other programmable logic device, discrete gate logic, transistor logic, registers, performance monitoring hardware, watchdog hardware, counters, and time references. SoCs may be integrated circuits (ICs) configured such that the components of the IC reside on the same substrate, such as a single piece of semiconductor material (such as, for example, silicon).

The term “system in a package” (SIP) is used herein to refer to a single module or package that may contain multiple resources, computational units, cores and/or processors on two or more IC chips, substrates, or SoCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP also may include multiple independent SoCs coupled together via high speed communication circuitry and packaged in close proximity, such as on a single motherboard or in a single mobile communication device. The proximity of the SoCs facilitates high speed communications and the sharing of memory and resources.

The term “multicore processor” is used herein to refer to a single IC chip or chip package that contains two or more independent processing cores (for example a CPU core, IP core, GPU core, among other examples) configured to read and execute program instructions. An SoC may include multiple multicore processors, and each processor in an SoC may be referred to as a core. The term “multiprocessor” may be used herein to refer to a system or device that includes two or more processing units configured to read and execute program instructions.

The wireless communication apparatus 1500 may include one or more modems 1502. In some implementations, the one or more modems 1502 (collectively “the modem 1502”) may include a WWAN modem (for example, a 3GPP 4G LTE or 5G compliant modem). In some implementations, the wireless communication apparatus 1500 also includes one or more radios 1504 (collectively “the radio 1504”). In some implementations, the wireless communication apparatus 1500 further includes one or more processors, processing blocks or processing elements 1506 (collectively “the processor 1506”) and one or more memory blocks or elements 1508 (collectively “the memory 1508”).

The modem 1502 can include an intelligent hardware block or device such as, for example, an application-specific integrated circuit (ASIC) among other possibilities. The modem 1502 is generally configured to implement a PHY layer. For example, the modem 1502 is configured to modulate packets and to output the modulated packets to the radio 1504 for transmission over the wireless medium. The modem 1502 is similarly configured to obtain modulated packets received by the radio 1504 and to demodulate the packets to provide demodulated packets. In addition to a modulator and a demodulator, the modem 1502 may further include digital signal processing (DSP) circuitry, automatic gain control (AGC), a coder, a decoder, a multiplexer and a demultiplexer. For example, while in a transmission mode, data obtained from the processor 1506 is provided to a coder, which encodes the data to provide encoded bits. The encoded bits are mapped to points in a modulation constellation (using a selected MCS) to provide modulated symbols. The modulated symbols may be mapped to a number NSS of spatial streams or a number NSTS of space-time streams. The modulated symbols in the respective spatial or space-time streams may be multiplexed, transformed via an inverse fast Fourier transform (IFFT) block, and subsequently provided to the DSP circuitry for Tx windowing and filtering. The digital signals may be provided to a digital-to-analog converter (DAC). The resultant analog signals may be provided to a frequency upconverter, and ultimately, the radio 1504. In implementations involving beamforming, the modulated symbols in the respective spatial streams are precoded via a steering matrix prior to their provision to the IFFT block.

While in a reception mode, digital signals received from the radio 1504 are provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also is coupled with the demodulator, which is configured to extract modulated symbols from the signal and, for example, compute the logarithm likelihood ratios (LLRs) for each bit position of each subcarrier in each spatial stream. The demodulator is coupled with the decoder, which may be configured to process the LLRs to provide decoded bits. The decoded bits from all of the spatial streams are fed to the demultiplexer for demultiplexing. The demultiplexed bits may be descrambled and provided to the MAC layer (the processor 1506) for processing, evaluation, or interpretation.

The radio 1504 generally includes at least one radio frequency (RF) transmitter (or “transmitter chain”) and at least one RF receiver (or “receiver chain”), which may be combined into one or more transceivers. For example, the RF transmitters and receivers may include various DSP circuitry including at least one power amplifier (PA) and at least one low-noise amplifier (LNA), respectively. The RF transmitters and receivers may, in turn, be coupled to one or more antennas. For example, in some implementations, the wireless communication apparatus 1500 can include, or be coupled with, multiple transmit antennas (each with a corresponding transmit chain) and multiple receive antennas (each with a corresponding receive chain). The symbols output from the modem 1502 are provided to the radio 1504, which transmits the symbols via the coupled antennas. Similarly, symbols received via the antennas are obtained by the radio 1504, which provides the symbols to the modem 1502.

The processor 1506 can include an intelligent hardware block or device such as, for example, a processing core, a processing block, a central processing unit (CPU), a microprocessor, a microcontroller, a digital signal processor (DSP), an application-specific integrated circuit (ASIC), a programmable logic device (PLD) such as a field programmable gate array (FPGA), discrete gate or transistor logic, discrete hardware components, or any combination thereof designed to perform the functions described herein. The processor 1506 processes information received through the radio 1504 and the modem 1502, and processes information to be output through the modem 1502 and the radio 1504 for transmission through the wireless medium. In some implementations, the processor 1506 may generally control the modem 1502 to cause the modem to perform various operations described throughout.

The memory 1508 can include tangible storage media such as random-access memory (RAM) or read-only memory (ROM), or combinations thereof. The memory 1508 also can store non-transitory processor- or computer-executable software (SW) code containing instructions that, when executed by the processor 1506, cause the processor to perform various operations described herein for wireless communication, including the generation, transmission, reception and interpretation of MPDUs, frames or packets. For example, various functions of components disclosed herein, or various blocks or steps of a method, operation, process or algorithm disclosed herein, can be implemented as one or more modules of one or more computer programs.

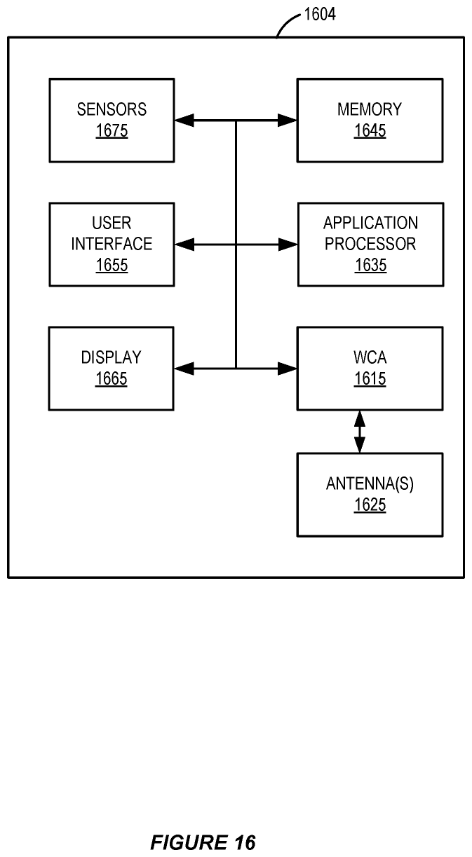

FIG. 16 shows a block diagram of an example mobile communication device 1604. For example, the mobile communication device 1604 can be an example implementation of the UE 120 described herein. The mobile communication device 1604 includes a wireless communication apparatus (WCA) 1615. For example, the WCA 1615 may be an example implementation of the wireless communication apparatus 1500 described with reference to FIG. 15. The mobile communication device 1604 also includes one or more antennas 1625 coupled with the WCA 1615 to transmit and receive wireless communications. The mobile communication device 1604 additionally includes an application processor 1635 coupled with the WCA 1615, and a memory 1645 coupled with the application processor 1635. In some implementations, the mobile communication device 1604 further includes a UI 1655 (such as a touchscreen or keypad) and a display 1665, which may be integrated with the UI 1655 to form a touchscreen display. In some implementations, the mobile communication device 1604 may further include one or more sensors 1675 such as, for example, one or more inertial sensors, accelerometers, temperature sensors, pressure sensors, or altitude sensors. Ones of the aforementioned components can communicate with other ones of the components directly or indirectly, over at least one bus. The mobile communication device 1604 further includes a housing that encompasses the WCA 1615, the application processor 1635, the memory 1645, and at least portions of the antennas 1625, UI 1655, and display 1665.

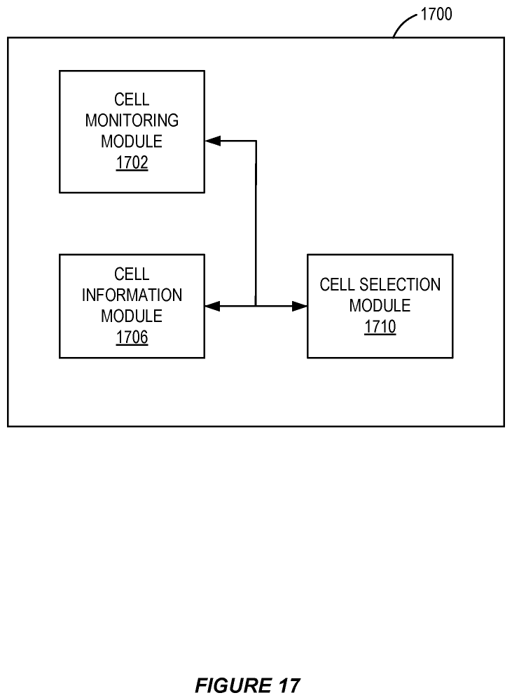

FIG. 17 shows a block diagram of another example wireless communication apparatus 1700 that supports cell selection techniques according to some implementations. In some implementations, the wireless communication apparatus 1700 is configured to perform one or more of the processes described with reference to processes 500, 900, or 1000 of FIG. 5, 9, or 10, respectively, or those described with reference to the UE 120 of FIGS. 4, 6, 7, 8, or those described with reference to the UEs 1220 and 1230 described with reference to FIG. 12, or any other processes described herein. The wireless communication apparatus 1700 may be an example implementation of the wireless communication apparatus 1500 described with reference to FIG. 15. For example, the wireless communication apparatus 1700 can be a chip, SoC, chipset, package or device that includes at least one modem (for example, a Wi-Fi (IEEE 802.11) modem or a cellular modem such as the modem 1102), at least one processor (such as the processing system 1106), at least one radio (such as the radio 1104) and at least one memory (such as the memory 1108). In some implementations, the wireless communication apparatus 1700 can be a device for use in a UE, such as one of the UEs 120 described with reference to any of the Figures described herein. In some other implementations, the wireless communication apparatus 1700 can be a UE that includes such a chip, SoC, chipset, package or device as well as at least one antenna.

The wireless communication apparatus 1700 may include a cell monitoring module 1702, a cell information module 1706, and a cell selection module 1710. Portions of one or more of the components 1702, 1706 and 1710 may be implemented at least in part in hardware or firmware. For example, the cell monitoring module 1702 may be implemented at least in part by a modem (such as the modem 1502). In some implementations, at least some of the components 1702, 1706 and 1710 are implemented at least in part as software stored in a memory (such as the memory 1508). For example, portions of one or more of the components 1702, 1706 and 1710 can be implemented as non-transitory instructions (or “code”) executable by a processor (such as the processing system 1506) to perform the functions or operations of the respective module.

The cell monitoring module 1702 may be configured to monitor one or more cells using a criterion indicative of a problematic cell. For example, the cell monitoring module 1702 may be configured to determine a quantity of ping-pong events or data transmission errors within a preceding time period.

The cell information module 1706 may be configured to receive cell information from an AP or a server. The cell information may include identifiers or location data associated with cells considered to be problematic cells by the AP. Alternatively, the cell information may be aggregated problematic cell information (crowdsourced problematic cell information) from multiple UEs.

The cell selection module 1710 may be configured to select a new cell for the UE to use for communication based on cell selection techniques (or mitigation techniques) that deprioritize problematic cells.

FIGS. 1-17 and the operations described herein are examples meant to aid in understanding example implementations and should not be used to limit the potential implementations or limit the scope of the claims. Some implementations may perform additional operations, fewer operations, operations in parallel or in a different order, and some operations differently.

The foregoing disclosure provides illustration and description but is not intended to be exhaustive or to limit the aspects to the precise form disclosed. Modifications and variations may be made in light of the above disclosure or may be acquired from practice of the aspects. While the aspects of the disclosure have been described in terms of various examples, any combination of aspects from any of the examples is also within the scope of the disclosure. The examples in this disclosure are provided for pedagogical purposes. Alternatively, or in addition to the other examples described herein, examples include any combination of the following implementation options (enumerated as clauses for clarity).

Clause 1. A method for wireless communication, including: monitoring, by a wireless communication apparatus of a user equipment (UE), one or more cells including at least a first cell of a wireless communication network in association with at least a first criterion, the first criterion associated with a history of ping-pong events or a history of data transmission errors indicative of problematic cells; selecting a primary cell of the wireless communication network using a cell selection criteria that deprioritizes selection of a first cell when the first cell is a problematic cell according to the first criterion; and communicating with the wireless communication network using the primary cell.

Clause 2. The method of clause 1, where monitoring the one or more cells includes: monitoring ping-pong events associated with the first cell, each ping-pong event including a first handover or reselection from the first cell to a second cell and a second handover or reselection from the second cell back to the first cell, where the first criterion is associated with a quantity of ping-pong events in a preceding time period.

Clause 3. The method of any one of clauses 1-2, where monitoring the ping-pong events associated with the first cell includes: monitoring the first cell as a potentially problematic cell when the quantity of ping-pong events in the preceding time period exceeds a first threshold; and confirming the first cell as the problematic cell when the quantity of ping-pong events in the preceding time period exceeds a second threshold.

Clause 4. The method of any one of clauses 1-3, where monitoring the one or more cells includes: monitoring the history of data transmission errors associated with the first cell; and confirming the first cell as the problematic cell when the history of data transmission errors is associated with the first criterion, the first criterion including at least one member selected from a group consisting of: a first quantity (N1) of uplink buffer errors in a preceding time period (T); a second quantity (N2) of uplink retransmissions in the preceding time period (T); and a third quantity (N3) of downlink reordering or reassembly errors in in the preceding time period (T).

Clause 5. The method of any one of clauses 1-4, where selecting the primary cell of the wireless communication network includes at least one member selected from a group consisting of: preventing selection of the problematic cell; deprioritizing cell selection measurements associated with the problematic cell; overriding or modifying a reporting criterion for a triggered measurement reporting event to reduce measurement reporting of the problematic cell, where the triggered measurement report event is associated with initiating a handover of the UE from a current serving cell to a neighbor cell; and refraining from sending the triggered measurement report for the problematic cell.

Clause 6. The method of any one of clauses 1-5, where measurement configuration includes a B1 reporting event specified in a technical standard and the reporting criterion for the B1 reporting event includes a signal measurement of the neighbor cell being greater than a first B1 threshold (B1-Threshold); and where overriding the measurement configuration includes replacing the B1 reporting event with a B2 reporting event such that the measurement reporting event is satisfied when a signal measurement of the current serving cell is worse than a first B2 threshold (B2-Threshold1) and the signal measurement of the neighbor cell is better than a second B2 threshold (B2-Threshold2).

Clause 7. The method of any one of clauses 1-6, further including: receiving, by the wireless communication apparatus of the UE, a list of cells considered to be problematic cells by an application processor (AP) or device processor of the UE; and monitoring at least one candidate cell that is in the list of cells from the AP or device processor using a second criterion for the candidate cell, where the second criterion has a lower threshold compared to the first criterion such that the monitoring expedites an indication of the candidate cell as a problematic cell.

Clause 8. The method of clause 7, further including: maintaining, by the wireless communication apparatus, a list of deprioritized cells including the first cell; and adding the candidate cell to the list of deprioritized cells when the candidate cell matches the second criterion.

Clause 9. The method of any one of clauses 7-8, where the first criterion is associated with a first quantity of ping-pong events in a first preceding time period, and where the second criterion is associated with a modification to the first criterion, the modification including at least one member selected from a group consisting of: a second quantity of ping-pong events that is lower than the first quantity of ping-pong events such that fewer ping-pong events are needed to confirm the candidate cell as the problematic cell compared to the first criterion; and a second preceding time period that is lower than the first preceding time period such that the candidate cell is confirmed as the problematic cell sooner compared to the first criterion.

Clause 10. The method of any one of clauses 7-9, where the first criterion is associated with the history of data transmission errors, and where the second criterion is associated with a modification to the first criterion, the modification including at least one member selected from a group consisting of: a fewer quantity (N1) of uplink buffer errors in a preceding time period (T) compared to the first criterion; a fewer quantity (N2) of uplink retransmissions in the preceding time period (T) compared to the first criterion; a fewer quantity (N3) of downlink reordering or reassembly errors in the preceding time period (T) compared to the first criterion; and a smaller preceding time period (T) compared to the first criterion.

Clause 11. The method of any one of clauses 7-10, further including: maintaining, by the wireless communication apparatus, a list of deprioritized cells including the first cell; comparing the list of cells from the AP or device processor with the list of deprioritized cells; and providing a status to the AP or device processor for each cell in the list of cells, where the status is selected from a group consisting of: confirmed as a problematic cell by the wireless communication apparatus, monitoring the cell as a potentially problematic cell, and not considered a problematic cell by the wireless communication apparatus.

Clause 12. The method of any one of clauses 1-11, further including: communicating an identification of the first cell as the problematic cell to a server that aggregates problematic cell information from more than one UE in the wireless communication network.

Clause 13. The method of clause 12, where the identification includes a cell global identity (CGI), a radio access technology (RAT) identifier, a physical cell identifier (PCI), an absolute radio frequency channel number (ARFCN), or any combination thereof.

Clause 14. The method of any one of clauses 12-13, further including: communicating a list of deprioritized cells including the first cell, the list of deprioritized cells including identifications, timestamps, and location data associated with one or more problematic cells of the list of deprioritized cells.

Clause 15. The method of any one of clauses 1-14, further including: receiving, from a server, aggregated problematic cell information that is associated with problematic cells identified by more than one UE in the wireless communication network.

Clause 16. The method of clause 15, where the cell selection criteria deprioritizes problematic cells identified in the aggregated problematic cell information.

Clause 17. The method of any one of clauses 15-16, where the aggregated problematic cell information includes location data associated with the problematic cells, and where the location data includes at least one member selected from a group consisting of: a location coordinate and distance radius such that the location coordinate and distance radius define one or more problematic areas associated with one or more problematic cells, a set of boundaries associated with a location such that the set of boundaries define a polygonal area that includes the one or more problematic areas associated with the one or more problematic cells, and one or more wireless local area network (WLAN) basic service set identifiers (BSSIDs) such that the cluster of problematic cells are identified by the UE when the UE detects the one or more WLAN BSSIDs.

Clause 18. A user equipment (UE), including: a wireless communication apparatus configured to: monitor one or more cells including at least a first cell of a wireless communication network in association with at least a first criterion, the first criterion associated with a history of ping-pong events or a history of data transmission errors indicative of problematic cells, and select a primary cell of the wireless communication network using a cell selection criteria that deprioritizes selection of a first cell when the first cell is a problematic cell according to the first criterion; and at least one modem configured to communicate with the wireless communication network using the primary cell.

Clause 19. The UE of clause 18, where the wireless communication apparatus is configured to: monitor ping-pong events associated with the first cell, each ping-pong event including a first handover or reselection from the first cell to a second cell and a second handover or reselection from the second cell back to the first cell, where the first criterion is associated with a quantity of ping-pong events in a preceding time period.

Clause 20. The UE of any one of clauses 18-19, where the wireless communication apparatus is configured to: monitor the first cell as a potentially problematic cell when the quantity of ping-pong events in the preceding time period exceeds a first threshold; and confirm the first cell as the problematic cell when the quantity of ping-pong events in the preceding time period exceeds a second threshold.

Clause 21. The UE of any one of clauses 18-20, where the wireless communication apparatus is configured to: monitor the history of data transmission errors associated with the first cell; and confirm the first cell as the problematic cell when the history of data transmission errors is associated with the first criterion, the first criterion including at least one member selected from a group consisting of: a first quantity (N1) of uplink buffer errors in a preceding time period (T); a second quantity (N2) of uplink retransmissions in the preceding time period (T); and a third quantity (N3) of downlink reordering or reassembly errors in in the preceding time period (T).

Clause 22. The UE of any one of clauses 18-21, where the wireless communication apparatus is configured to select the primary cell of the wireless communication network by at least one member selected from a group consisting of: preventing selection of the problematic cell; deprioritizing cell selection measurements associated with the problematic cell; overriding or modifying a reporting criterion for a triggered measurement reporting event to reduce measurement reporting of the problematic cell, where the triggered measurement report event is associated with initiating a handover of the UE from a current serving cell to a neighbor cell; and refraining from sending the triggered measurement report for the problematic cell.

Clause 23. The UE of clause 22, where measurement configuration includes a B1 reporting event specified in a technical standard and the reporting criterion for the B1 reporting event includes a signal measurement of the neighbor cell being greater than a first B1 threshold (B1-Threshold); and where overriding the measurement configuration includes replacing the B1 reporting event with a B2 reporting event such that the reporting criterion is satisfied when a signal measurement of the current serving cell is worse than a first B2 threshold (B2-Threshold1) and the signal measurement of the neighbor cell is better than a second B2 threshold (B2-Threshold2).

Clause 24. The UE of any one of clauses 18-23, further including: an application processor (AP) or device processor, where the wireless communication apparatus configured to: obtain a list of cells considered to be problematic cells by AP or the device processor, and monitor at least one candidate cell that is in the list of cells from the AP or device processor using a second criterion for the candidate cell, where the second criterion has a lower threshold compared to the first criterion such that the monitoring expedites an indication of the candidate cell as a problematic cell.

Clause 25. The UE of clause 24, where the wireless communication apparatus configured to: maintain a list of deprioritized cells including the first cell; and add the candidate cell to the list of deprioritized cells when the candidate cell matches the second criterion.

Clause 26. The UE of any one of clauses 24-25, where the first criterion is associated with a first quantity of ping-pong events in a first preceding time period, and where the second criterion is associated with a modification to the first criterion, the modification including at least one member selected from a group consisting of: a second quantity of ping-pong events that is lower than the first quantity of ping-pong events such that fewer ping-pong events are needed to confirm the candidate cell as the problematic cell compared to the first criterion; and a second preceding time period that is lower than the first preceding time period such that the candidate cell is confirmed as the problematic cell sooner compared to the first criterion.

Clause 27. The UE of any one of clauses 24-26, where the first criterion is associated with the history of data transmission errors, and where the second criterion is associated with a modification to the first criterion, the modification including at least one member selected from a group consisting of: a fewer quantity (N1) of uplink buffer errors in a preceding time period (T) compared to the first criterion; a fewer quantity (N2) of uplink retransmissions in the preceding time period (T) compared to the first criterion; a fewer quantity (N3) of downlink reordering or reassembly errors in the preceding time period (T) compared to the first criterion; and a smaller preceding time period (T) compared to the first criterion.

Clause 28. The UE of any one of clauses 24-27, where the wireless communication apparatus configured to: maintain a list of deprioritized cells including the first cell; compare the list of cells from the AP or device processor with the list of deprioritized cells; and output, to the AP or the device processor, a status for each cell in the list of cells, where the status is selected from a group consisting of: confirmed as a problematic cell by the wireless communication apparatus, monitoring the cell as a potentially problematic cell, and not considered a problematic cell by the wireless communication apparatus.

Clause 29. The UE of any one of clauses 18-28, where the at least one modem is further configured to communicate an identification of the first cell as the problematic cell to a server that aggregates problematic cell information from more than one UE in the wireless communication network.

Clause 30. The UE of clause 29, where the identification includes a cell global identity (CGI), a radio access technology (RAT) identifier, a physical cell identifier (PCI), an absolute radio frequency channel number (ARFCN), or any combination thereof.

Clause 31. The UE of any one of clauses 29-30, further including: where the at least one modem is further configured to communicate a list of deprioritized cells including the first cell, the list of deprioritized cells including identifications, timestamps, and location data associated with one or more problematic cells of the list of deprioritized cells.

Clause 32. The UE of any one of clauses 18-31, further including: where the at least one modem is further configured to obtain, from a server, aggregated problematic cell information that is associated with problematic cells identified by more than one UE in the wireless communication network.

Clause 33. The UE of clause 32, where the cell selection criteria deprioritizes problematic cells identified by the aggregated problematic cell information.

Clause 34. The UE of any one of clauses 32-33, where the aggregated problematic cell information includes location data associated with the problematic cells, and where the location data includes at least one member selected from a group consisting of: a location coordinate and distance radius such that the location coordinate and distance radius define one or more problematic areas associated with one or more problematic cells, a set of boundaries associated with a location such that the set of boundaries define a polygonal area that includes the one or more problematic areas associated with the one or more problematic cells, and one or more wireless local area network (WLAN) basic service set identifiers (BSSIDs) such that the one or more problematic areas associated with the one or more problematic cells are identified by the UE when the UE detects the one or more WLAN BSSIDs.

Clause 35. The UE of any one of clauses 18-34, further including: at least one transceiver coupled to the at least one modem; at least one antenna coupled to the at least one transceiver to wirelessly transmit signals output from the at least one transceiver and to wirelessly receive signals for input into the at least one transceiver; and a housing that encompasses at least the wireless communication apparatus, the at least one modem, the at least one transceiver, and at least a portion of the at least one antenna.

Clause 36. A server for managing mobility in a wireless communication network, including: a communication unit configured to obtain cell information from more than one user equipment (UE) in the wireless communication network, the cell information identifying one or more problematic cells; and a processing system configured to generate aggregated problematic cell information associated with the one or more problematic cells identified by the cell information, where the communication unit is further configured to output the aggregated problematic cell information to a recipient.

Clause 37. The server of clause 36, where the recipient includes at least one member selected from a group consisting of: a UE; a network operator; and an application provider.

Clause 38. The server of any one of clauses 36-37, where the aggregated problematic cell information an identification of at least a first cell as a problematic cell, and where the identification includes a cell global identity (CGI), a radio access technology (RAT) identifier, a physical cell identifier (PCI), an absolute radio frequency channel number (ARFCN), or any combination thereof.

Clause 39. The server of any one of clauses 36-38, where the aggregated problematic cell information includes identifications, timestamps, and location data associated with the one or more problematic cells.

Clause 40. The server of any one of clauses 36-39, where the aggregated problematic cell information includes location data associated with the one or more problematic cells, and where the location data includes at least one member selected from a group consisting of: a location coordinate and distance radius such that the location coordinate and distance radius define a cluster of problematic cells, a set of boundaries associated with a location such that the set of boundaries define a polygonal area that includes the cluster of problematic cells, and one or more wireless local area network (WLAN) basic service set identifiers (BSSIDs) such that the cluster of problematic cells are identified by the UE when the UE detects the one or more WLAN BSSIDs.

Clause 41. A method for managing mobility in a wireless communication network, including: receiving cell information from more than one user equipment (UE) in the wireless communication network, the cell information identifying one or more problematic cells; and generating aggregated problematic cell information associated with the one or more problematic cells identified by the cell information; and communicating the aggregated problematic cell information to a recipient.

Clause 42. The method of clause 41, where the recipient includes at least one member selected from a group consisting of: a UE; a network operator; and an application provider.

Clause 43. The method of any one of clauses 41-42, where the aggregated problematic cell information an identification of at least a first cell as a problematic cell, and where the identification includes a cell global identity (CGI), a radio access technology (RAT) identifier, a physical cell identifier (PCI), an absolute radio frequency channel number (ARFCN), or any combination thereof.

Clause 44. The method of any one of clauses 41-43, where the aggregated problematic cell information includes identifications, timestamps, and location data associated with the one or more problematic cells.

Clause 45. The method of any one of clauses 41-44, where the aggregated problematic cell information includes location data associated with the one or more problematic cells, and where the location data includes at least one member selected from a group consisting of: a location coordinate and distance radius such that the location coordinate and distance radius define a cluster of problematic cells, a set of boundaries associated with a location such that the set of boundaries define a polygonal area that includes the cluster of problematic cells, and one or more wireless local area network (WLAN) basic service set identifiers (BSSIDs) such that the cluster of problematic cells are identified by the UE when the UE detects the one or more WLAN BSSIDs.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.”

Some aspects are described herein in connection with thresholds. As used herein, satisfying a threshold may refer to a value being greater than the threshold, greater than or equal to the threshold, less than the threshold, less than or equal to the threshold, equal to the threshold, not equal to the threshold, or the like.

As used herein, a phrase referring to “at least one of” or “one or more of” a list of items refers to any combination of those items, including single members. For example, “at least one of: a, b, or c” is intended to cover the possibilities of: a only, b only, c only, a combination of a and b, a combination of a and c, a combination of b and c, and a combination of a and b and c.

The various illustrative components, logic, logical blocks, modules, circuits, operations and algorithm processes described in connection with the implementations disclosed herein may be implemented as electronic hardware, firmware, software, or combinations of hardware, firmware or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

The hardware and data processing apparatus used to implement the various illustrative components, logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, or any conventional processor, controller, microcontroller, or state machine. A processor also may be implemented as a combination of computing devices, for example, a combination of a DSP and a microprocessor, multiple microprocessors, one or more microprocessors in conjunction with a DSP core, or any other such configuration. In some implementations, particular processes, operations and methods may be performed by circuitry that is specific to a given function.

As described above, in some aspects implementations of the subject matter described in this specification can be implemented as software. For example, various functions of components disclosed herein, or various blocks or steps of a method, operation, process or algorithm disclosed herein can be implemented as one or more modules of one or more computer programs. Such computer programs can include non-transitory processor- or computer-executable instructions encoded on one or more tangible processor- or computer-readable storage media for execution by, or to control the operation of, data processing apparatus including the components of the devices described herein. By way of example, and not limitation, such storage media may include RAM, ROM, EEPROM, CD-ROM or other optical disk storage, magnetic disk storage or other magnetic storage devices, or any other medium that may be used to store program code in the form of instructions or data structures. Combinations of the above should also be included within the scope of storage media.

As used herein, the terms “user equipment”, “wireless communication device”, “mobile communication device”, “communication device”, or “mobile device” refer to any one or all of cellular telephones, smartphones, portable computing devices, personal or mobile multi-media players, laptop computers, tablet computers, smartbooks, Internet-of-Things (IoT) devices, palm-top computers, wireless electronic mail receivers, multimedia Internet enabled cellular telephones, wireless gaming controllers, display sub-systems, driver assistance systems, vehicle controllers, vehicle system controllers, vehicle communication system, infotainment systems, vehicle telematics systems or subsystems, vehicle display systems or subsystems, vehicle data controllers or routers, and similar electronic devices which include a programmable processor and memory and circuitry configured to perform operations as described herein.

As used herein, the terms “SIM,” “SIM card,” and “subscriber identification module” are used interchangeably to refer to a memory that may be an integrated circuit or embedded into a removable card, and that stores an International Mobile Subscriber Identity (IMSI), related key, or other information used to identify or authenticate a mobile communication device on a network and enable a communication service with the network. Because the information stored in a SIM enables the mobile communication device to establish a communication link for a particular communication service with a particular network, the term “subscription” is used herein as a shorthand reference to refer to the communication service associated with and enabled by the information stored in a particular SIM as the SIM and the communication network, as well as the services and subscriptions supported by that network, correlate to one another. A SIM used in various examples may contain user account information, an international mobile subscriber identity (IMSI), a set of SIM application toolkit (SAT) commands, and storage space for phone book contacts. A SIM card may further store home identifiers (such as, a System Identification Number (SID)/Network Identification Number (NID) pair, a Home Public Land Mobile Number (HPLMN) code, among other examples) to indicate the SIM card network operator provider. An Integrated Circuit Card Identity (ICCID) SIM serial number may be printed on the SIM card for identification. However, a SIM may be implemented within a portion of memory of the mobile communication device, and thus need not be a separate or removable circuit, chip or card.

Various modifications to the implementations described in this disclosure may be readily apparent to persons having ordinary skill in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Additionally, various features that are described in this specification in the context of separate implementations also can be implemented in combination in a single implementation. Conversely, various features that are described in the context of a single implementation also can be implemented in multiple implementations separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

1. A method for wireless communication, comprising:
monitoring, by a wireless communication apparatus of a user equipment (UE), one or more cells including at least a first cell of a wireless communication network in association with at least a first criterion, the first criterion associated with a history of ping-pong events or a history of data transmission errors indicative of problematic cells;
selecting a primary cell of the wireless communication network using a cell selection criteria that deprioritizes selection of a first cell when the first cell is a problematic cell according to the first criterion; and
communicating with the wireless communication network using the primary cell.

2. The method of claim 1, wherein monitoring the one or more cells includes:
monitoring ping-pong events associated with the first cell, each ping-ping event including a first handover or reselection from the first cell to a second cell and a second handover or reselection from the second cell back to the first cell, wherein the first criterion is associated with a quantity of ping-pong events in a preceding time period.

3. The method of claim 2, wherein monitoring the ping-pong events associated with the first cell includes:
monitoring the first cell as a potentially problematic cell when the quantity of ping-pong events in the preceding time period exceeds a first threshold; and
confirming the first cell as the problematic cell when the quantity of ping-pong events in the preceding time period exceeds a second threshold.

4. The method of claim 1, wherein monitoring the one or more cells includes:
monitoring the history of data transmission errors associated with the first cell; and
confirming the first cell as the problematic cell when the history of data transmission errors is associated with the first criterion, the first criterion including at least one member selected from a group consisting of:
a first quantity (N1) of uplink buffer errors in a preceding time period (T);
a second quantity (N2) of uplink retransmissions in the preceding time period (T); and
a third quantity (N3) of downlink reordering or reassembly errors in in the preceding time period (T).

5. The method of claim 1, wherein selecting the primary cell of the wireless communication network includes at least one member selected from a group consisting of:
preventing selection of the problematic cell;
deprioritizing cell selection measurements associated with the problematic cell;
overriding or modifying a reporting criterion for a triggered measurement reporting event to reduce measurement reporting of the problematic cell, wherein the triggered measurement report event is associated with initiating a handover of the UE from a current serving cell to a neighbor cell; and
refraining from sending the triggered measurement report for the problematic cell.

6. The method of claim 5,
wherein measurement configuration includes a B1 reporting event specified in a technical standard and the reporting criterion for the B1 reporting event includes a signal measurement of the neighbor cell being greater than a first B1 threshold (B1-Threshold); and
wherein overriding the measurement configuration includes replacing the B1 reporting event with a B2 reporting event such that the measurement reporting event is satisfied when a signal measurement of the current serving cell is worse than a first B2 threshold (B2-Threshold1) and the signal measurement of the neighbor cell is better than a second B2 threshold (B2-Threshold2).

7. The method of claim 1, further comprising:
receiving, by the wireless communication apparatus of the UE, a list of cells considered to be problematic cells by an application processor (AP) or device processor of the UE; and
monitoring at least one candidate cell that is in the list of cells from the AP or device processor using a second criterion for the candidate cell, wherein the second criterion has a lower threshold compared to the first criterion such that the monitoring expedites an indication of the candidate cell as a problematic cell.

8. (canceled)

9. The method of claim 7,
wherein the first criterion is associated with a first quantity of ping-pong events in a first preceding time period, and
wherein the second criterion is associated with a modification to the first criterion, the modification including at least one member selected from a group consisting of:
a second quantity of ping-pong events that is lower than the first quantity of ping-pong events such that fewer ping-pong events are needed to confirm the candidate cell as the problematic cell compared to the first criterion; and
a second preceding time period that is lower than the first preceding time period such that the candidate cell is confirmed as the problematic cell sooner compared to the first criterion.

10. The method of claim 7,
wherein the first criterion is associated with the history of data transmission errors, and
wherein the second criterion is associated with a modification to the first criterion, the modification including at least one member selected from a group consisting of:
a fewer quantity (N1) of uplink buffer errors in a preceding time period (T) compared to the first criterion;
a fewer quantity (N2) of uplink retransmissions in the preceding time period (T) compared to the first criterion;
a fewer quantity (N3) of downlink reordering or reassembly errors in the preceding time period (T) compared to the first criterion; and
a smaller preceding time period (T) compared to the first criterion.

11. (canceled)

12. The method of claim 1, further comprising:
communicating an identification of the first cell as the problematic cell to a server that aggregates problematic cell information from more than one UE in the wireless communication network.

13-14. (canceled)

15. The method of claim 1, further comprising:
receiving, from a server, aggregated problematic cell information that is associated with problematic cells identified by more than one UE in the wireless communication network.

16-17. (canceled)

18. A user equipment (UE), comprising:
a wireless communication apparatus configured to:
monitor one or more cells including at least a first cell of a wireless communication network in association with at least a first criterion, the first criterion associated with a history of ping-pong events or a history of data transmission errors indicative of problematic cells, and
select a primary cell of the wireless communication network using a cell selection criteria that deprioritizes selection of a first cell when the first cell is a problematic cell according to the first criterion; and
at least one modem configured to communicate with the wireless communication network using the primary cell.

19. The UE of claim 18, wherein the wireless communication apparatus is configured to:
monitor ping-pong events associated with the first cell, each ping-pong event including a first handover or reselection from the first cell to a second cell and a second handover or reselection from the second cell back to the first cell, wherein the first criterion is associated with a quantity of ping-pong events in a preceding time period.

20-21. (canceled)

22. The UE of claim 18, wherein the wireless communication apparatus is configured to select the primary cell of the wireless communication network by at least one member selected from a group consisting of:
preventing selection of the problematic cell;
deprioritizing cell selection measurements associated with the problematic cell;
overriding or modifying a reporting criterion for a triggered measurement reporting event to reduce measurement reporting of the problematic cell, wherein the triggered measurement report event is associated with initiating a handover of the UE from a current serving cell to a neighbor cell; and
refraining from sending the triggered measurement report for the problematic cell.

23. (canceled)

24. The UE of claim 18, further comprising:
an application processor (AP) or device processor,
wherein the wireless communication apparatus configured to:
obtain a list of cells considered to be problematic cells by AP or the device processor, and
monitor at least one candidate cell that is in the list of cells from the AP or device processor using a second criterion for the candidate cell, wherein the second criterion has a lower threshold compared to the first criterion such that the monitoring expedites an indication of the candidate cell as a problematic cell.

25. The UE of claim 24, wherein the wireless communication apparatus configured to:
maintain a list of deprioritized cells including the first cell; and
add the candidate cell to the list of deprioritized cells when the candidate cell matches the second criterion.

26-27. (canceled)

28. The UE of claim 24, wherein the wireless communication apparatus configured to:
maintain a list of deprioritized cells including the first cell;
compare the list of cells from the AP or device processor with the list of deprioritized cells; and
output, to the AP or the device processor, a status for each cell in the list of cells, wherein the status is selected from a group consisting of:
confirmed as a problematic cell by the wireless communication apparatus,
monitoring the cell as a potentially problematic cell, and
not considered a problematic cell by the wireless communication apparatus.

29. The UE of claim 18,
wherein the at least one modem is further configured to communicate an identification of the first cell as the problematic cell to a server that aggregates problematic cell information from more than one UE in the wireless communication network, and
wherein the identification includes a cell global identity (CGI), a radio access technology (RAT) identifier, a physical cell identifier (PCI), an absolute radio frequency channel number (ARFCN), or any combination thereof.

30. (canceled)

31. The UE of claim 29, further comprising:
wherein the at least one modem is further configured to communicate a list of deprioritized cells including the first cell, the list of deprioritized cells including identifications, timestamps, and location data associated with one or more problematic cells of the list of deprioritized cells.

32. The UE of claim 18, further comprising:
wherein the at least one modem is further configured to obtain, from a server, aggregated problematic cell information that is associated with problematic cells identified by more than one UE in the wireless communication network.

33. The UE of claim 32, wherein the cell selection criteria deprioritizes problematic cells identified by the aggregated problematic cell information.

34. The UE of claim 33, wherein the aggregated problematic cell information includes location data associated with the problematic cells, and wherein the location data includes at least one member selected from a group consisting of:
a location coordinate and distance radius such that the location coordinate and distance radius define one or more problematic areas associated with one or more problematic cells,
a set of boundaries associated with a location such that the set of boundaries define a polygonal area that includes the one or more problematic areas associated with the one or more problematic cells, and
one or more wireless local area network (WLAN) basic service set identifiers (BSSIDs) such that the one or more problematic areas associated with the one or more problematic cells are identified by the UE when the UE detects the one or more WLAN BSSIDs.

35. UE of claim 18, further comprising:
at least one transceiver coupled to the at least one modem;
at least one antenna coupled to the at least one transceiver to wirelessly transmit signals output from the at least one transceiver and to wirelessly receive signals for input into the at least one transceiver; and
a housing that encompasses at least the wireless communication apparatus, the at least one modem, the at least one transceiver, and at least a portion of the at least one antenna.

36. A server for managing mobility in a wireless communication network, comprising:
a communication unit configured to obtain cell information from more than one user equipment (UE) in the wireless communication network, the cell information identifying one or more problematic cells; and
a processing system configured to generate aggregated problematic cell information associated with the one or more problematic cells identified by the cell information,
wherein the communication unit is further configured to output the aggregated problematic cell information to a recipient.

37. The server of claim 36, wherein the recipient includes at least one member selected from a group consisting of:
a UE;
a network operator; and
an application provider.

38. The server of claim 36, wherein the aggregated problematic cell information an identification of at least a first cell as a problematic cell, and wherein the identification includes a cell global identity (CGI), a radio access technology (RAT) identifier, a physical cell identifier (PCI), an absolute radio frequency channel number (ARFCN), or any combination thereof.

39. (canceled)

40. The server of claim 36, wherein the aggregated problematic cell information includes location data associated with the one or more problematic cells, and wherein the location data includes at least one member selected from a group consisting of:
a location coordinate and distance radius such that the location coordinate and distance radius define a cluster of problematic cells,
a set of boundaries associated with a location such that the set of boundaries define a polygonal area that includes the cluster of problematic cells, and
one or more wireless local area network (WLAN) basic service set identifiers (BSSIDs) such that the cluster of problematic cells are identified by the UE when the UE detects the one or more WLAN BSSIDs.

41. A method for managing mobility in a wireless communication network, comprising:
receiving cell information from more than one user equipment (UE) in the wireless communication network, the cell information identifying one or more problematic cells; and
generating aggregated problematic cell information associated with the one or more problematic cells identified by the cell information; and
communicating the aggregated problematic cell information to a recipient.

42. (canceled)

43. The method of claim 41, wherein the aggregated problematic cell information an identification of at least a first cell as a problematic cell, and wherein the identification includes a cell global identity (CGI), a radio access technology (RAT) identifier, a physical cell identifier (PCI), an absolute radio frequency channel number (ARFCN), or any combination thereof.

44. The method of claim 41, wherein the aggregated problematic cell information includes identifications, timestamps, and location data associated with the one or more problematic cells.

45. (canceled)
